(19) United States
(12) Patent Application Publication
(10) Pub. No.: US 2011/0215250 A1
(43) Pub. Date: Sep. 8, 2011

(54) RADIOGRAPHIC IMAGE CAPTURING DEVICE

(75) Inventors: Yasunori OHTA, Kanagawa (JP); Naoyuki NISHINO, Kanagawa (JP); Haruyasu NAKATSUGAWA, Kanagawa (JP); Naoto IWAKIRI, Kanagawa (JP)

(73) Assignee: FUJIFILM CORPORATION, Tokyo (JP)

(21) Appl. No.: 13/007,679

(22) Filed: Jan. 17, 2011

(30) Foreign Application Priority Data
Mar. 3, 2010 (JP) 2010-047137
Mar. 30, 2010 (JP) 2010-079522
Nov. 18, 2010 (JP) 2010-258015
Nov. 18, 2010 (JP) 2010-258017

(51) Int. Cl. G01T 1/24

(52) U.S. Cl. 250/370.08

(57) ABSTRACT

A radiographic image according to an embodiment includes two radiation detectors and a light blocking layer. Each of the radiation detectors includes a light generation layer that generates light due to irradiation of radiation, and a substrate that accumulates charge by receiving light generated at the light generation layer and includes switch elements for reading the charge. The two radiation detectors are superimposed on each other. The light blocking layer is disposed between the two radiation detectors, and blocks light generated by each of the light generation layers of the two radiation detectors from the other light generation layer.

This application claims priority under 35 USC 119 from Japanese Patent Applications No. 2010-047137 filed on Mar. 3, 2010, No. 2010-079522 filed on Mar. 30, 2010, No. 2010-258015 filed on Nov. 18, 2010, and No. 2010-258017 filed on Nov. 18, 2010, the disclosures of which are incorporated by reference herein.

### BACKGROUND OF THE INVENTION

### Field of the Invention

The present invention relates to a radiographic image capturing device.

Radiation detectors such as flat panel detectors (FPDs), in which a radiation-sensitive layer is disposed on a thin film transistor (TFT) active matrix substrate and that detect irradiated radiation such as X-rays or the like and output electric signals expressing the radiographic image expressed by the detected radiation, and the like have been put into practice in recent years. As compared with a conventional imaging plate, a radiation detector has the advantages that images can be confirmed immediately, and even video images can be confirmed.

Portable radiographic image capturing devices (hereinafter also called electronic cassettes) that incorporate a radiation detector therein and capture radiographic image also are being put into practice.

In surgery, it is important to be able to display radiographic images immediately after image capture in order to perform rapid and accurate procedures on a patient. Electronic cassettes enable rapid checking of images and can meet these requirements.

As a technology related to this type of radiation detector, Japanese Patent Application Laid-Open (JP-A) No. 9-145845 discloses a radiation detector in which a first scintillator is formed on one face of a photoelectric conversion section capable of receiving light from both the front face and the side face, and a second scintillator is formed on the other face of the photoelectric conversion section, and configured such that first scintillator, the photoelectric conversion section, and the second scintillator are stacked in this order. According to this technology, in order to capture an image, X-rays are irradiated from the first scintillator side, and while the first scintillator emits light, the second scintillator emits light due to X-rays that have passed through the first scintillator. Thus, higher sensitivity can be achieved by receiving light in the photoelectric conversion section generated from both the first scintillator and the second scintillator.

JP-A No. 2007-163467 discloses a radiation detector equipped with two scintillator layers for converting irradiated radiation into light, with a solid-state photodetector disposed between the two layers of scintillator, for detecting light converted by the two layers of scintillator and converting to an electrical signal.

Further, JP-A No. 7-27865 discloses a technique for obtaining an energy subtraction image by superimposing two radiation detectors so as to face each other, reading radiographic images from the respective radiation detectors during image capture, and performing a weighted addition of the two radiographic images that have been read.

However, in the radiation detectors of the technologies of JP-A No. 9-145845 and JP-A No. 2007-163467, while higher sensitivity can be achieved by receiving light generated from both of the two scintillators, light generated in the two scintillators cannot be separately detected. Therefore, radiographic images cannot be obtained separately of the light generated by each of the scintillators, and image capture with another radiographic image capturing device would need to be performed if an energy subtraction image is desired from radiographic images of light generated by two scintillators.

Further, radiographic images used in the medical field generally have high resolution for diagnosis, and the higher the precision raised, the greater the volume of data, the time taken for image processing and data transmission, and the storage space required for storing the image data. Accordingly, there are occasions when the ability to change the resolution is desired.

In investigations there are occasions when it is desired to perform radiographic image capture with changed resolution, sensitivity and/or image characteristics. For example, after an investigation is performed with radiographic image capture at a standard resolution, there is a case that re-investigation is required using an investigation image capture with higher resolution.

However, respective applications are restricted for the radiation detectors of JP-A No. 9-145845 and JP-A No. 7-27865. For example, whereas the radiation detector of JP-A No. 9-145845 is capable of radiographic image capture at high sensitivity, the resolution cannot be changed, and image capture with another radiographic image capturing device would need to be performed when image capture of a high resolution image is required, or if desired to obtain an energy subtraction image. While the radiation detector of JP-A No. 7-27865 is able to obtain an energy subtraction image, the sensitivity and the image characteristics cannot be changed, and image capture with another radiographic image capturing device would need to be performed if a high sensitivity image, or image capture of an image with different image characteristics was required.

### SUMMARY OF THE INVENTION

In consideration of the above circumstances, the present invention provides a radiographic image capturing device capable of use in multiple applications.

A first aspect of the present invention is a radiographic image capturing device including: two radiation detectors, each radiation detector including a light generation layer that generates light due to irradiation of radiation, and a substrate that accumulates charge by receiving light generated at the light generation layer and includes switch elements for reading the charge, and the two radiation detectors being superimposed on each other; and a light blocking layer disposed between the two radiation detectors, the light blocking layer blocking light generated by each of the light generation layers of the two radiation detectors from the other light generation layer.

Accordingly, in the configuration of the present aspect, the light blocking layer is provided between the two radiation detectors blocking light generated by each of the light generation layers of the two radiation detectors from the other light generation layer. Due to this configuration, light in the light generation layer of one of the radiation detectors is not incident to the other radiation detector, and light in the light generation layer of the other radiation detector is also not incident to the first radiation detector. Thus, radiographic images due to light generated in the light generation layers can be separately detected, which enables multiple applications of the radiographic image capturing device.

Another aspect of the present invention is a radiographic image capturing device including: an image capture section including at least two image capture systems that capture radiographic images expressing irradiated radiation, the image capture section being capable of separately reading image data expressing radiographic images captured by each of the image capture systems; a reception section that receives processing conditions for each of the image capture systems of the image capture section; and a management section capable of performing selective processing for each of the image capture systems and managing processing for each of the image capture systems according to the processing conditions.

According to the present aspect, the radiographic image capturing device receives processing conditions for each of the image capture systems capable of separately reading image data expressing radiographic images captured by each of the image capture systems, and selects processing for each of the image capture systems of the image capture section, thereby managing processing for each of the image capture systems according to the received processing conditions. This configuration enables multiple applications of the radiographic image capturing device.

According to the present aspects, a radiographic image capturing device can be provided capable of use in multiple applications.

### BRIEF DESCRIPTION OF THE DRAWINGS

Exemplary embodiments of the present invention will be described in detail based on the following figures, wherein:

FIG. 1 is a cross-sectional view schematically showing a configuration of a radiation detector according to an exemplary embodiment;

FIG. 2 is a plan view showing a configuration of a radiation detector according to the exemplary embodiment;

FIG. 3 is a cross-sectional view schematically showing a configuration of a TFT substrate according to the exemplary embodiment;

FIG. 4 is a cross-sectional view showing a configuration of a radiation detector according to the exemplary embodiment;

FIG. 5 is a graph showing changes in sensitivity according to thickness of a scintillator layer according to the exemplary embodiment;

FIG. 6 is a graph showing changes in image quality according to thickness of a scintillator layer according to the exemplary embodiment;

FIG. 7 is a cross-sectional view showing a configuration of an image capture section according to the exemplary embodiment;

FIG. 8 is a schematic diagram showing a multi-layered structure of small particles and large particles in a scintillator layer;

FIG. 9 is a cross-sectional view showing a configuration in a case in which a reflection layer is formed on the opposite side of a scintillator layer to the side having a TFT substrate;

FIG. 10 is a perspective view showing a configuration of a flat plate shaped electronic cassette according to the exemplary embodiment;

FIG. 11 is a cross-sectional view showing a configuration of the flat plate shaped electronic cassette according to the exemplary embodiment;

FIG. 12 is a block diagram showing main portions of an electrical system of the electronic cassette according to the exemplary embodiment;

FIG. 13 is a perspective view showing a stacked configuration of two radiation detectors, gate line drivers and signal processing sections according to the exemplary embodiment;

FIG. 14 is a flow chart showing a flow of an image reading processing program according to a first exemplary embodiment;

FIG. 15 is a perspective view showing a configuration of an openable and closable electronic cassette according to an exemplary embodiment;

FIG. 16 is a perspective view showing a configuration of the openable and closable electronic cassette according to the exemplary embodiment;

FIG. 17 is a cross-sectional view showing a configuration of the openable and closable electronic cassette according to the exemplary embodiment;

FIG. 18 is a perspective view showing a configuration of a reversible electronic cassette according to an exemplary embodiment;

FIG. 19 is a perspective view showing a configuration of the reversible electronic cassette according to the exemplary embodiment;

FIG. 20 is a cross-sectional view showing a configuration of the reversible electronic cassette according to the exemplary embodiment;

FIG. 21 is a plan view showing pixel arrays of two radiation detectors according to a second exemplary embodiment;

FIG. 22 is a flow chart showing a flow of an image reading processing program according to the second exemplary embodiment;

FIG. 23 is a diagram schematically showing interpolation processing according to the second exemplary embodiment;

FIG. 24 is a cross-sectional view showing another configuration of an image capture section according to an exemplary embodiment;

FIG. 25 is a cross-sectional view showing another configuration of an image capture section according to an exemplary embodiment;

FIG. 26 is a cross-sectional view showing another configuration of an image capture section according to an exemplary embodiment;

FIG. 27 is a cross-sectional view showing another configuration of an image capture section according to an exemplary embodiment;

FIG. 28 is a graph showing the relationship between cumulative irradiated amount and sensitivity of CsI;

FIG. 29A is a cross-sectional view showing a configuration of an openable and closable electronic cassette according to another exemplary embodiment in a folded state, and FIG. 29B is a cross-sectional view showing a configuration of the openable and closable electronic cassette according to the other exemplary embodiment in an open state;

FIG. 30 is a cross-sectional view showing another configuration of an image capture section according to an exemplary embodiment;

FIG. 31 is a cross-sectional view showing another configuration of an image capture section according to an exemplary embodiment;

FIG. 32 is a cross-sectional view schematically showing a direct conversion type of radiation detector according to another embodiment;

FIG. 33 is a graph showing an example of changes in sensitivity of a scintillator layer configured with CsI;

FIG. 34 is a schematic view showing an example of an image capture section according another exemplary embodiment in which a detection panel is provided at one side thereof; and

FIG. 35 is a cross-sectional view showing another configuration of an image capture section according to an exemplary embodiment.

### DETAILED DESCRIPTION OF THE INVENTION

### First Exemplary Embodiment

Explanation will first be given regarding a configuration of a radiation detector 20 according to the first exemplary embodiment.

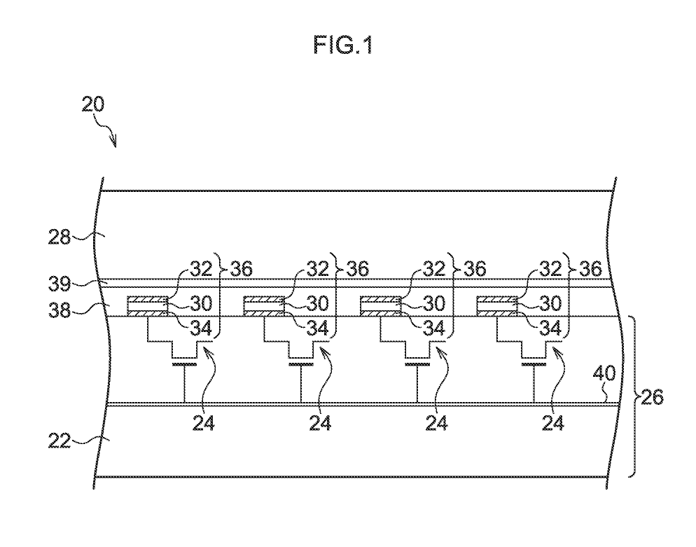

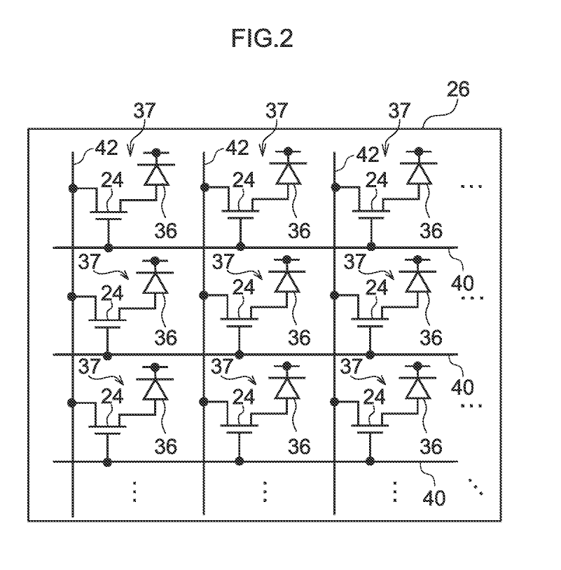

FIG. 1 shows a schematic cross-sectional view of a configuration of the radiation detector 20 according to the first exemplary embodiment and FIG. 2 shows a plan view of a configuration of the radiation detector 20.

As shown in FIG. 1, the radiation detector 20 has a TFT substrate 26 at which switch elements 24 such as thin film transistors (TFTs) are formed on an insulating substrate 22.

A scintillator layer 28, that converts incident radiation into light, is formed on the TFT substrate 26 as an example of a radiation converting layer that converts incident radiation.

For example, CsI:Tl or GOS (Gd₂O₂S:Tb) can be used as the scintillator layer 28. Note that the scintillator layer 28 is not limited to these materials.

Preferably the wavelength region of light emitted by the scintillator layer 28 is in the visible light region (wavelengths from 360 nm to 830 nm), and more preferably includes a green wavelength region to enable monochrome image capture with the radiation detector 20.

Specifically, fluorescent materials employed in the scintillator layer 28 preferably include cesium iodide (CsI) for cases in which X-rays are employed as radiation, and particularly preferably include thallium doped cesium iodide (CsI (Tl)) having an emission spectrum of wavelengths 420 nm to 700 nm during X-ray irradiation. The emission peak wavelength of CsI (Tl) in the visible light region is at 565 nm.

Vapor deposition onto a vapor deposition substrate may be employed to form the scintillator layer 28 by, for example, by columnar crystals of CsI (Tl) or the like. Often an Al plate is employed for the vapor deposition substrate in cases in which the scintillator layer 28 is formed thus by vapor deposition, due to its X-ray transmissivity and cost perspective, however there is no limitation thereto. For cases in which GOS is employed as the scintillator layer 28, the scintillator layer 28 may be formed by coating GOS on the front face of the TFT substrate 26 without using a vapor deposition substrate.

Any substrate having light transmissivity and low absorption to radiation may be employed for the insulating substrate 22 and, for example, a glass substrate, a transparent ceramic substrate, or a light transmitting resin substrate can be employed. The insulating substrate 22 is not limited to these materials.

Photoconductive layers 30, that generate charges due to the light converted by the scintillator layer 28 being incident thereon, are disposed between the scintillator layer 28 and the TFT substrate 26. Bias electrodes 32 for applying bias voltage to the photoconductive layers 30 are formed on the scintillator layer 28 side surfaces of the photoconductive layers 30.

The photoconductive layers 30 absorb light that has been generated from the scintillator layer 28, and generates charge according to the light that has been absorbed. The photoconductive layers 30 may be formed from a material that generates charge on illumination with light, and can, for example, be formed from amorphous silicon, an organic photoelectric conversion material, or the like. Photoconductive layers 30 containing amorphous silicon have a wide absorption spectrum and can absorb light that has been generated in the scintillator layer 28. Photoconductive layers 30 containing an organic photoelectric conversion material have an absorption spectrum with a sharp peak in the visible light region, and there is substantially no absorption by the photoconductive layers 30 of electromagnetic waves other than the light generated by the scintillator layer 28, thereby enabling effective suppression of noise generation by absorption of radiation, such as X-rays or the like, in the photoconductive layers 30.

In order to most efficiently absorb the light that is emitted at the scintillator layer 28, it is preferable that the absorption peak wavelength of the organic photoelectric conversion material that structures the photoconductive layer 30 be nearer to the emission peak wavelength of the scintillator layer 28. It is ideal that the absorption peak wavelength of the organic photoelectric conversion material and the emission peak wavelength of the scintillator layer 28 coincide, but if the difference therebetween is small, the light emitted from the scintillator layer 28 can be absorbed sufficiently. Specifically, it is preferable that the difference between the absorption peak wavelength of the organic photoelectric conversion material and the emission peak wavelength, with respect to radiation, of the scintillator layer 28 be within 10 nm, and it is more preferable for the difference to be within 5 nm.

Examples of organic photoelectric conversion materials that can satisfy such a condition are, for example, quinacridone organic compounds and phthalocyanine organic compounds. For example, the absorption peak wavelength in the visible range of quinacridone is 560 nm. Therefore, if quinacridone is used as the organic photoelectric conversion material and CsI(Tl) is used as the material of the scintillator layer 28, the difference in the peak wavelengths can be made to be within 5 nm, and the amount of charges generated at the photoconductive layer 30 can be made to be substantially the maximum.

Charge collecting electrodes 34, that collect the charges generated at the photoconductive layers 30, are formed at the TFT substrate 26. At the TFT substrate 26, the charges collected at the respective charge collecting electrodes 34 are read-out by the switch elements 24.

Specific explanation now follows of regarding the photoconductive layers 30 applicable to the radiation detector 20 according to the present exemplary embodiment.

Electromagnetic wave absorption/photoelectric conversion region at the radiation detector 20 can be structured by a bias electrode 32 and a charge collecting electrode 34 that form a pair, and an organic layer that contains the organic photoconductive layer 30 that is sandwiched between the bias electrode 32 and the charge collecting electrode 34. This organic layer can be formed by the stacking of or the combining of a region that absorbs electromagnetic waves, a photoelectric conversion region, an electron transport region, a hole transport region, an electron blocking region, a hole blocking region, a crystallization preventing region, electrodes, an interlayer contact improving region, and the like.

It is preferable that the organic layer contain an organic p-type compound or an organic n-type compound.

An organic p-type semiconductor (compound) is a donor organic semiconductor (compound) exemplified mainly by hole-transporting organic compounds, and means an organic compound that has the property that it easily donates electrons. More specifically, an organic p-type semiconductor (compound) means, when two organic materials are used by being made to contact one another, the organic compound whose ionization potential is smaller. Accordingly, any organic compound can be used as the donor organic compound, provided that it is an electron-donating organic compound.

An organic n-type semiconductor (compound) is an accepter organic semiconductor (compound) exemplified mainly by electron-transporting organic compounds, and means an organic compound that has the property that it easily accepts electrons. More specifically, an organic n-type semiconductor (compound) means, when two organic compounds are used by being made to contact one another, the organic compound whose electron affinity is greater. Accordingly, any organic compound can be used as the accepter organic compound, provided that it is an electron-accepting organic compound.

Materials that can be used as the organic p-type semiconductor and the organic n-type semiconductor, and the structure of the photoconductive layer 30, are described in detail in JP-A No. 2009-32854, which is incorporated by reference herein, and therefore, description thereof is omitted.

Note that the photoconductive layers 30 may be formed so as to further include fullerenes and/or carbon nanotubes.

It suffices for a sensor portion 36 that structures each pixel portion of the radiation detector 20 to include at least the charge collecting electrode 34, the photoconductive layer 30 and the bias electrode 32. However, in order to suppress an increase in dark current, it is preferable that the sensor portion 36 be provided with at least one of an electron blocking film and a hole blocking film, and it is more preferable that the sensor portion 36 be provided with the both.

The electron blocking film can be provided between the charge collecting electrode 34 and the photoconductive layer 30. The electron blocking film can suppress the injection of electrons from the charge collecting electrode 34 into the photoconductive layer 30 and an increase in dark current, when bias voltage is applied between the charge collecting electrode 34 and the bias electrode 32.

An electron-donating organic material can be used for the electron blocking film.

It suffices to select the material, that is actually used for the electron blocking film, in accordance with the material of the electrode adjacent thereto, the material of the photoconductive layer 30 adjacent thereto, and the like. It is preferable that the material have an electron affinity (Ea) that is 1.3 eV or more greater than the work function (Wf) of the material of the electrode adjacent thereto, and have an ionization potential (Ip) that is equal to or smaller than the ionization potential of the material of the photoconductive layer 30 adjacent thereto. Materials that can be used as this electron-donating organic material are described in detail in JP-A No. 2009-32854, and therefore, description thereof is omitted.

In order to reliably exhibit a dark current suppressing effect and to prevent a decrease in the photoelectric conversion efficiency of the sensor portion 36, it is preferable that the thickness of the electron blocking film be from 10 nm to 200 nm, and more preferable that the thickness be from 30 nm to 150 nm, and particularly preferable that the thickness be from 50 nm to 100 nm.

The hole blocking film can be provided between the photoconductive layer 30 and the bias electrode 32. The hole blocking film can suppress the injecting of holes from the bias electrode 32 into the photoconductive layer 30 and an increase in dark current, when bias voltage is applied between the charge collecting electrode 34 and the bias electrode 32.

An electron-accepting organic material can be used for the hole blocking film.

In order to reliably exhibit a dark current suppressing effect and to prevent a decrease in the photoelectric conversion efficiency of the sensor portion 36, it is preferable that the thickness of hole blocking film be from 10 nm to 200 nm, and more preferable that the thickness be from 30 nm to 150 nm, and particularly preferable that the thickness be from 50 nm to 100 nm.

It suffices to select the material, that is actually used for the hole blocking film, in accordance with the material of the electrode adjacent thereto, the material of the photoconductive layer 30 adjacent thereto, and the like. It is preferable that the material have an ionization potential (Ip) that is 1.3 eV or more greater than the work function (Wf) of the material of the electrode adjacent thereto, and have an electron affinity (Ea) that is equal to or greater than the electron affinity of the material of the photoconductive layer 30 adjacent thereto. Materials that can be used as this electron-accepting organic material are described in detail in JP-A No. 2009-32854, and therefore, description thereof is omitted.

Note that the position of the electron blocking film and the hole blocking film may be reversed in cases in which there is a bias voltage set such that holes from charges generated in the photoconductive layer 30 move towards the bias electrode 32, and electrons from the charges move towards the charge collecting electrode 34. In is not necessary to provide both the electron blocking film and the hole blocking film; a certain degree of dark current suppressing effect can be obtained as long as one or other thereof is provided.

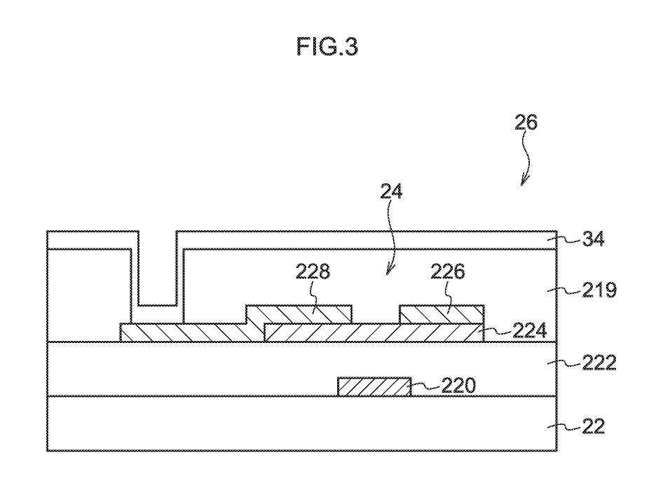

The structure of the switch element 24 is shown schematically in FIG. 3.

In the TFT substrate 26, the switch elements 24 are formed corresponding to the charge collecting electrodes 34, and charge that has moved into the charge collecting electrode 34 is converted into an electrical signal and the electrical signal output by the switch elements 24. The region in which each of the switch elements 24 is formed has a portion that overlaps with the charge collecting electrode 34 in plan view. By configuring thus, the switch elements 24 and the sensor portions 36 overlap along the thickness direction in each of the pixels. Note that in order to minimized the surface area of the radiation detector 20 (pixel portions) the regions formed with the switch elements 24 are preferably completely covered by the charge collecting electrodes 34.

At the switch element 24, a gate electrode 220, a gate insulating film 222 and an active layer (channel layer) 224 are layered, and further, the switch element 24 is structured such that a source electrode 226 and a drain electrode 228 are formed on the active layer 224 with a predetermined interval therebetween.

The drain electrode 228 is electrical connected to a corresponding charge collecting electrode 34 through a wiring of an electrically conductive material formed so as to penetrate through an insulating layer 219 provided between the insulating substrate 22 and the charge collecting electrode 34. Charge trapped by the charge collecting electrode 34 can thereby be moved to the switch element 24.

The active layer 224 can, for example, be formed from amorphous silicon, an amorphous (non-crystalline) oxide, an organic semiconductor material, carbon nanotubes or the like. Note that the material for forming the active layer 224 is not limited to these materials.

As the amorphous oxide that can structure the active layer 224, oxides containing at least one of In, Ga and Zn (e.g., In—O types) are preferable, oxides containing at least two of In, Ga and Zn (e.g., In—Zn—O types, In—Ga—O types, Ga—Zn—O types) are more preferable, and oxides containing In, Ga and Zn are particularly preferable. As an In—Ga—Zn—O type amorphous oxide, amorphous oxides whose composition in a crystal state is expressed by InGaO₃(ZnO)ₘ (where m is a natural number of less than 6) are preferable, and in particular, InGaZnO₄ is more preferable. Note that amorphous oxide that can form the active layer 224 is not limited to these.

Possible organic semiconductor materials for configuring the active layer 224 include phthalocyanine compounds, pentacene, vanadyl phthalocyanine and the like, however there is no limitation thereto. Since explanation of details regarding structures of such phthalocyanine compounds is given in JP-A No. 2009-212389, which is incorporated by reference herein, further explanation is omitted.

By forming the active layer 224 of the switch elements 24 from amorphous oxides, organic semiconductor materials, or carbon nanotubes, since there is no absorption of radiation such as X-rays, or any absorption is restricted to an extremely small amount, noise generation in the switch elements 24 can be effectively suppressed.

When the active layer 224 is formed with carbon nanotubes, the switching speed of the switch elements 24 can be increased, and the switch elements 24 can be formed having a low degree of absorption of light in the visible light region. Note that in cases in which the active layer 224 is formed with carbon nanotubes, since the performance of the switch elements 24 deteriorates significantly with incorporation of only a minute amount of metal impurity in the active layer 224, extremely high purity carbon nanotubes need to be separated or extracted, such as by centrifugal separation, for formation.

The above amorphous compounds, organic semiconductor materials, carbon nanotubes and organic photoelectric conversion materials are all capable of being formed into a film at low temperature. Accordingly, the insulating substrate 22 is not limited to a substrate with high heat resistance, such as a semiconductor substrate, a quartz substrate, a glass substrate or the like, and a flexible substrate such as from a plastic, an aramid, or a bionanofiber substrate can be employed. Specifically, a flexible substrate including a polyester such as polyethylene terephthalate, polybutylene phthalate, polyethylene naphthalate, polystyrene, polycarbonate, polyethersulphone, a polyarylate, a polyimide, a polycyclic olefin, a norbornene resin, a poly (chloro trifluouro ethylene) or the like, can be employed. By employing such a plastic flexible substrate, a reduction in weight can be achieved which is beneficial to portability.

Furthermore, an insulation layer to ensure insulation ability, a gas barrier layer for preventing moisture and oxygen transmission, an undercoat layer for flattening and/or raising adhesiveness to the electrodes, or other layers may be provided to the insulating substrate 22.

Since an aramid can be used in high temperature process applications of 200° C. or above, a transparent electrode material can be high-temperature hardened to give a low resistance, and compatibility can also be made to automatic packaging of driver ICs including solder re-flow processes. Since an aramid has a thermal expansion coefficient that is close to that of indium tin oxide (ITO) and glass substrate, post manufacture warping is small, and it is not readily broken. An aramid can also be formed in a relatively thin substrate in comparison to a glass substrate. Therefore, the insulating substrate 22 may be formed with an aramid layered on an ultrathin glass substrate.

A bionanofiber is a composite of cellulose micro-fibril bundles (bacteria cellulose), produced by the bacterium Acetobacter Xylinum, and a transparent resin. The cellulose micro-fibril bundles are, with a width of 50 nm, a size that is 1/10 that of visible wavelengths, and have high strength, high elasticity, and low thermal expansion. By impregnating and hardening the bacteria cellulose in a transparent resin, such as an acrylic resin, an epoxy resin, a bionanofiber is obtained with a light transmissivity of 90% to light at 500 nm wavelength, while including fibers at a proportion of 60% to 70%. The bionanofiber has a low thermal expansion coefficient (3 to 7 ppm/K), comparable to that of crystalline silicon, strength comparable to steel (460 MPa), high elasticity (30 GPa) and is also flexible. This enables the insulating substrate 22 to be formed thinner in comparison to configuration with a glass substrate or the like.

In the present exemplary embodiment, the switch elements 24, the sensor portions 36 and a flattening layer 38 are formed in this sequence on the insulating substrate 22. The radiation detector 20 is formed by attaching the scintillator layer 28 above the insulating substrate 22 with a bonding layer 39 employing a bonding resin of low light absorption. The insulating substrate 22 formed up to the flattening layer 38 is referred to below as the TFT substrate 26.

As shown in FIG. 2, the TFT substrate 26 is configured with plural pixels 37 each configured to include the sensor portion 36 and the switch element 24. The sensor portions 36 are configured with the bias electrodes 32, the photoconductive layers 30, and the charge collecting electrodes 34, and function as a photodiode, generating charge according to incident light. The switch elements 24 read the charge that has accumulated in the sensor portions 36. Plural of the pixels 37 are provided in a two-dimensional shape, along one direction (the row direction of FIG. 2) and a direction that intersects with the row direction (the column direction of FIG. 2).

Plural gate lines 40, extending in the one direction (row direction) for switching each of the switch elements 24 ON or OFF, and plural data lines 42, extending in the intersecting direction (column direction) for reading out charge through the switch elements 24 that are in the ON state, are provided on the TFT substrate 26.

The flattening layer 38 (see FIG. 1) is formed over the TFT substrate 26 for flattening above the TFT substrate 26. The bonding layer 39 is formed between the TFT substrate 26 and the scintillator layer 28 and above the flattening layer 38, for bonding the scintillator layer 28 to the TFT substrate 26.

The TFT substrate 26 is a quadrilateral shape in plan view, having four sides at the outside edges thereof. Specifically, the TFT substrate 26 is formed in a rectangular shape.

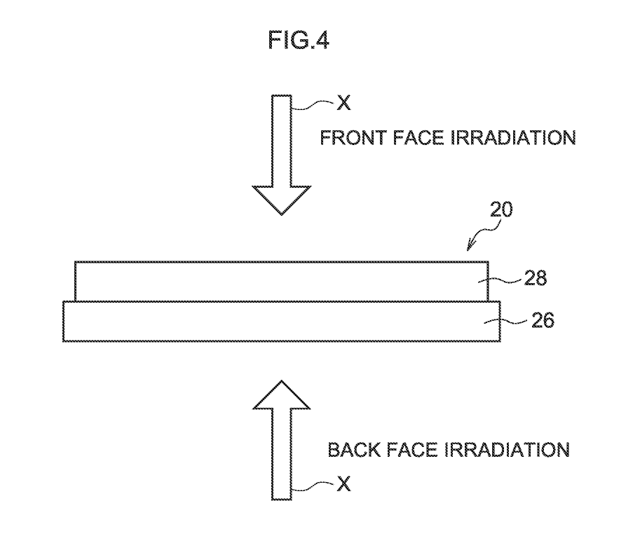

As shown in FIG. 4, the radiation detector 20 may be irradiated with radiation from the front side on which the scintillator layer 28 has been adhered (front face irradiation/back face reading method, called a Penetration Side Sampling (PSS) method), or may be irradiated with radiation from the TFT substrate 26 side (back side) (back face irradiation/front face reading method, called an Irradiation Side Sampling (ISS) method). When the radiation detector 20 is irradiated with radiation from the front side, there is more intense light generation at the top face side of the scintillator layer 28 (the opposite side to that of the TFT substrate 26). However, when radiation is irradiated from the back side, radiation that has passed through the TFT substrate 26 is irradiated onto the scintillator layer 28, and light generation is more intense at the TFT substrate 26 side of the scintillator layer 28. Charge is generated in each of the photoconductive layers 30 due to the light generated in the scintillator layer 28. Accordingly, the radiation detector 20 can be designed to have a higher sensitivity to radiation when radiation is irradiated from the front side than when radiation is irradiated from the back side, since radiation does not pass through the TFT substrate 26. Further, the resolution of the radiographic images obtained by image capture is higher when radiation is irradiated from the back side than when radiation is irradiated from the front side, since the light generation position in the scintillator layer 28 is nearer to the photoconductive layers 30.

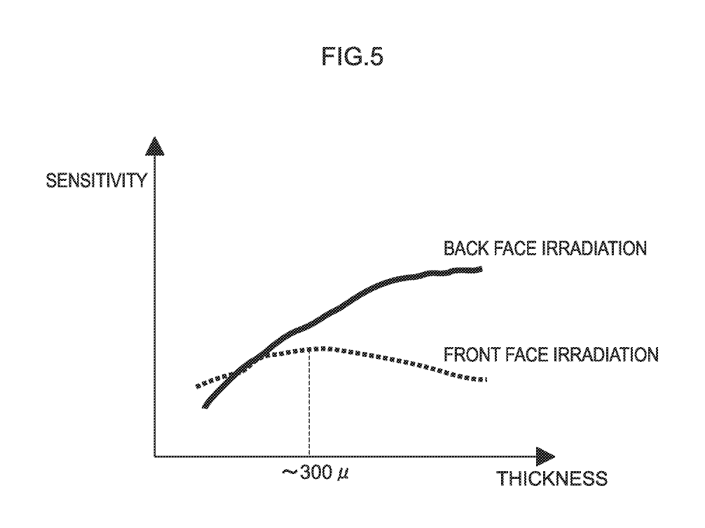

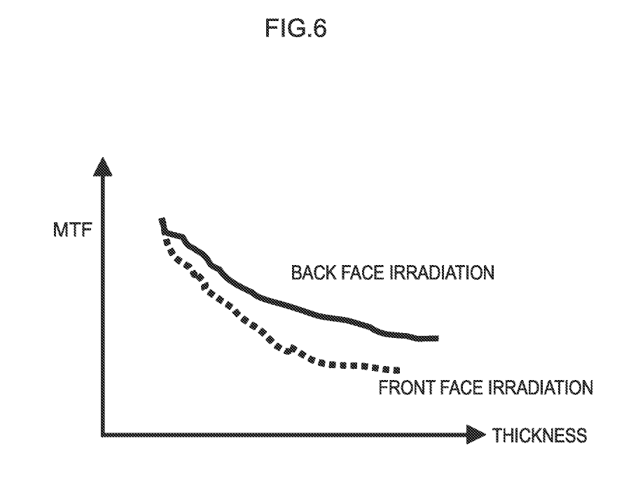

FIG. 5 shows an example of changes in sensitivity with changing thickness of the scintillator layer 28 when irradiation is performed to the front face of the radiation detector 20 and when irradiation is performed to the back face of the radiation detector 20. FIG. 6 shows an example of changes to the Modulation Transfer Factor (MTF) with changing thickness of the scintillator layer 28 when radiation is irradiated from the front face of the radiation detector 20 and when radiation is irradiated from the back face of the radiation detector 20.

Explanation now follows regarding a configuration of an image capture section 21 for performing radiographic image capture.

The image capture section 21 of the present exemplary embodiment includes two image capture systems for capturing radiographic images expressed by irradiated radiation, and is configured capable of separately reading image data expressing radiographic images captured by each of the image capture systems.

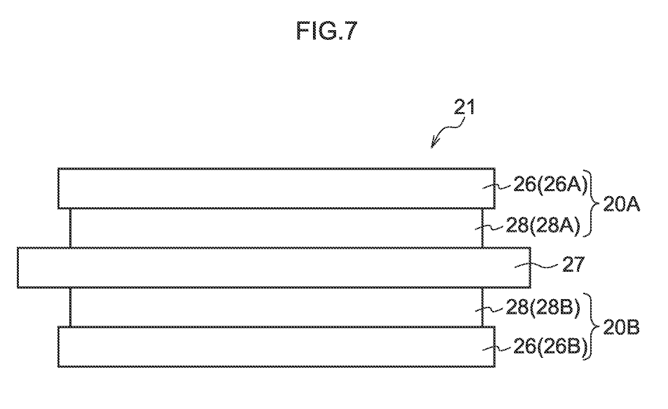

Specifically, as shown in FIG. 7, two radiation detectors 20 (20A, 20B) are disposed such that their scintillator layers 28 are positioned respectively at the top face and bottom face of a light blocking plate 27 that allows radiation to pass through but shields light (i.e., disposed such that the scintillator layer 28 sides of the radiation detectors 20A, 20B face each other on either side of the light blocking plate 27). When differentiating between the scintillator layers 28 and the TFT substrates 26 of the radiation detectors 20A, 20B, explanation is given in which the scintillator layer 28 and the TFT substrate 26 of the radiation detector 20A are appended with the suffix A, and the scintillator layer 28 and the TFT substrate 26 of the radiation detector 20B are appended with the suffix B.

The scintillator layer 28A and the TFT substrate 26A are thus provided in sequence on one (first) face of the light blocking plate 27, with radiation from the first face side being back face irradiation for the radiation detector 20A. The scintillator layer 28B and the TFT substrate 26B are provided in sequence on the other (second) face of the light blocking plate 27, with radiation from the second face side being back face irradiation for the radiation detector 20B. Due to provision of the light blocking plate 27 between the two radiation detectors 20A, 20B, light generated by the scintillator layer 28A does not pass through to the scintillator layer 28B side, and light generated by the scintillator layer 28B does not pass through to the scintillator layer 28A side.

Here, the light generation characteristics of the scintillator layer 28 vary according to its thickness, as shown in FIG. 5 and FIG. 6.

As the thickness of the scintillator layer 28 increases, the amount of light generated increases and sensitivity is raised, however image quality (image sharpness) decreases due to light scattering and the like.

Accordingly, by making the thickness of the scintillator layer 28B larger than that of the scintillator layer 28A, the image capture section 21 can be configured such that the scintillator layer 28A side is used when image quality (image sharpness) is given priority, and the scintillator layer 28B side is used when sensitivity is given priority. Note that when the thickness of the scintillator layers 28 is less than 50 μm, sufficient output in response to X-rays is not obtained. In cases of front face irradiation, when the thickness exceeds 300 μm, reflected light scatters and is absorbed within the scintillator layer 28, such that there tends to be an insufficient quantity of light exiting from the front face. Therefore, in cases of front face irradiation, the thickness of the scintillator layer 28 is preferably in the range from 50 to 300 μm, and is more preferably in the range from 100 to 250 μm.

In the scintillator layers 28, the greater the particle diameter of particles filled in the scintillator layer 28 and generating light by irradiation with radiation, the greater the amount of light generated and sensitivity. However, the image quality is reduced due to light scattering and influence of particles contacting the detection pixel to the adjacent pixels.

Accordingly, by setting the diameter of the particles of the scintillator layer 28B larger than that of the 28A, the scintillator layer 28A side can be configured image quality focused and the scintillator layer 28B side can be configured sensitivity focused.

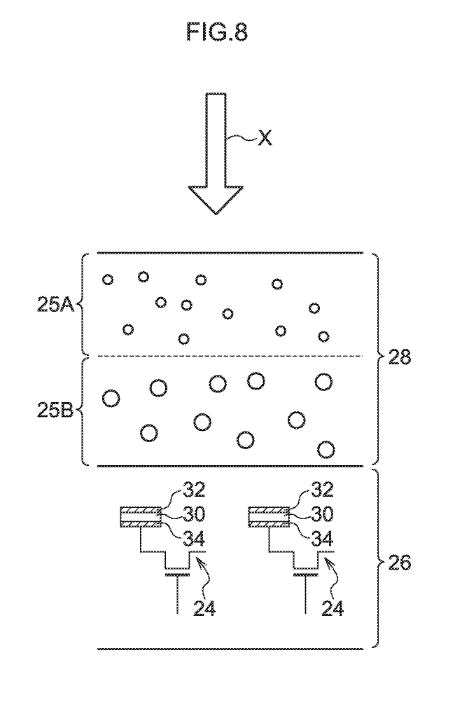

The scintillator layers 28 can be configured with a multi-layer structure of small diameter particles and large diameter particles. For example, as shown in FIG. 8, there is little blurring of images when the scintillator layer 28 is configured with a region 25A of small diameter particles on the irradiation side and a region 25B of large diameter particles on the TFT substrate 26 side. However, the sensitivity is reduced due to the difficulty of non-perpendicular components of light generated in and radiating out from the small diameter particles reaching the TFT substrate 26. The sensitivity is raised if the proportions of the region 25A and the region 25B are changed and the proportion of the large diameter particle layer is made greater than the small diameter particle layer. However, this may reduce the image quality due to the influence of scattering on the adjacent pixels.

Accordingly, by changing the multilayer structure of the particles of the scintillator layers 28A, 28B, the scintillator layer 28A side can be configured image quality focused, and the scintillator layer 28B side can be configured for sensitivity focused.

As the fill rate of the scintillator layer 28 increases the sensitivity is raised, however, since scattering of light also increases, the image quality decreases. The fill rate is a value obtained by (the total volume of particles in the scintillator layer 28)/(the volume of the scintillator layer 28)×100. Since manufacturing of the scintillator layer 28 having the fill rate greater than 80% by volume is difficult from the perspective of particle handling, the fill rate is preferably 50 to 80% by volume.

By making the fill rate of the particles in the scintillator layer 28B greater than that of the scintillator layer 28A, the scintillator layer 28A side can be configured image quality focused and the scintillator layer 28B side can be configured sensitivity focused.

In the scintillator layers 28, the light generating characteristics vary with the amount of doping with additives, with the light generation amount tending to increase the larger the amount of doping with additives; however, since this also causes light scattering to be increase, image quality decreases.

Accordingly, by setting the doping amount of additives in the scintillator layer 28B greater than that of the scintillator layer 28A, the scintillator layer 28A can be configured image quality focused, and the scintillator layer 28B can be configured sensitivity focused.

The light generation characteristics in response to radiation may be changed when the material employed for the scintillator layer 28 varies.

For example, by forming the scintillator layer 28A with GOS and forming the scintillator layer 28B with CsI:Tl, the scintillator layer 28A may be configured sensitivity focused and the scintillator layer 28B may be configured image quality focused.

The light generation characteristics in response to radiation may be different according to the layer structure, whether a layer structure with tabular or columnar separation is employed.

For example, by making the scintillator layer 28A with tabular layer structure, and the scintillator layer 28B with columnar separation layer structure, the scintillator layer 28A may be configured sensitivity focused and the scintillator layer 28B may be configured for image quality focused.

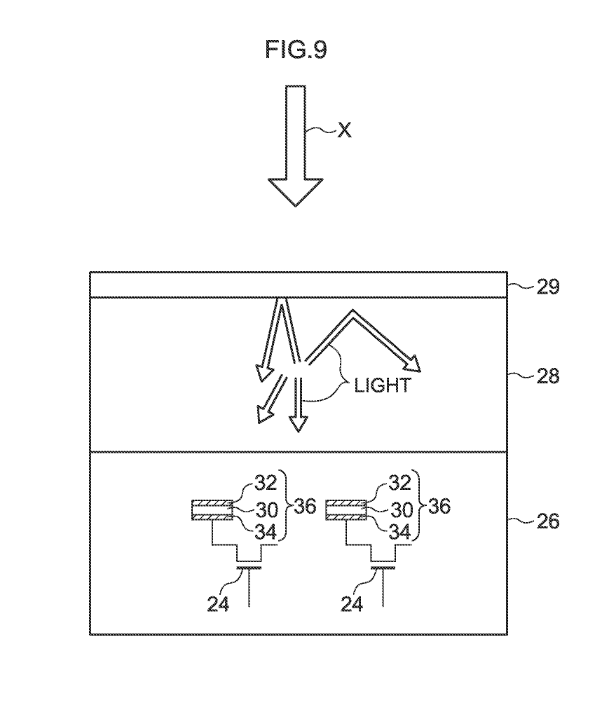

As shown in FIG. 9, sensitivity is raised by forming a reflection layer 29, which lets X-ray radiation pass through but reflects visible light, on the face of the scintillator layer 28 on the opposite side to that of the TFT substrate 26, in order to guide generated light more efficiently to the TFT substrate 26. A sputtering method, a vacuum deposition method or a coating method may be employed as the method for providing the reflection layer 29. For the reflection layer 29, a material is preferably used having a high reflectivity to the light generation wavelength regions of the employed scintillator layer 28, such as, for example, Au, Ag, Cu, Al, Ni, Ti and the like. When the scintillator layer 28 is formed by GOS:Tb, a layer of Ag, Al, Cu or the like may be employed, having high reflectivity to wavelengths from 400 to 600 nm, with the layer thickness preferably 0.01 to 3 μm, since reflectivity is not obtained at a thickness of less than 0.01 μm, and there is no further effect obtained to raise the reflectivity by exceeding 3 μm.

As discussed, different characteristics can be imparted to the scintillator layers 28 by adjusting one or any combinations of particle diameter, multi-layer structure of the particles, fill rate of the particles, doping amount of additives, material, changing the layer structure, and forming the reflection layer 29.

Further, the light receiving characteristics in the TFT substrates 26A, 26B can be changed by one or any combinations of: changing the material of the photoconductive layers 30; forming a filter between the TFT substrate 26A and the scintillator layer 28A and/or between the TFT substrate 26B and the scintillator layer 28B; changing the light receiving surface area of the photoconductive layers 30 that function as photodiodes in the TFT substrate 26A and the TFT substrate 26B, such that the light receiving surface area of the sensitivity focused side is made greater than on the image quality focused side; changing the pixel pitch between the TFT substrate 26A and the TFT substrate 26B so as to be narrower on the image quality focused side than on the sensitivity focused side; and by varying signal reading characteristics of the TFT substrates 26A, 26B.

In the present exemplary embodiment, the properties of radiographic images captured by the radiation detectors 20A, 20B are made different from each other by one or any combinations of: changing the thickness, particle diameter, multi-layer structure of the particles, fill rate of the particles, doping amount of additives, material, and/or the layer structure for the scintillator layers 28A, 28B; forming the reflection layer 29 in the scintillator layers 28A, 28B; forming a filter between the TFT substrate 26A and the scintillator layer 28A and/or between the TFT substrate 26B and the scintillator layer 28B; changing the light receiving surface area of the photoconductive layers 30 that function as photodiodes in the TFT substrate 26A and the TFT substrate 26B, such that the light receiving surface area of the sensitivity focused side is made greater than on the image quality focused side; and changing the pixel pitch between the TFT substrate 26A and the TFT substrate 26B so as to be narrower on the image quality focused side than on the sensitivity focused side.

Specifically, in the present exemplary embodiment, the radiation detector 20A is configured image quality focused, and the radiation detector 20B is configured sensitivity focused.

Explanation now follows regarding a configuration of an electronic cassette 10 installed with such an image capture section 21.

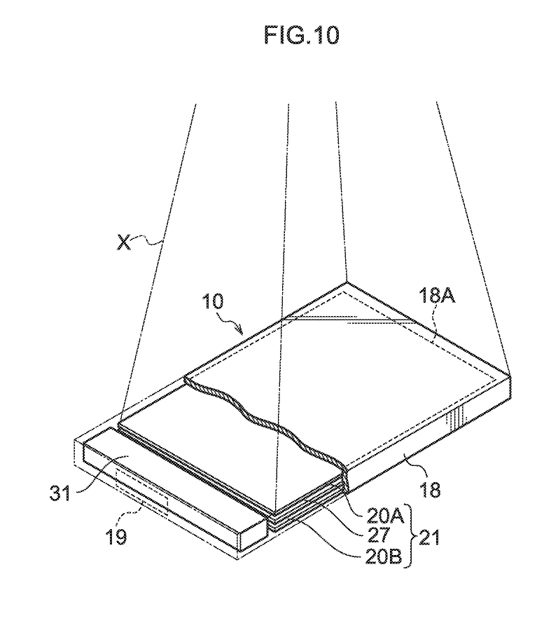

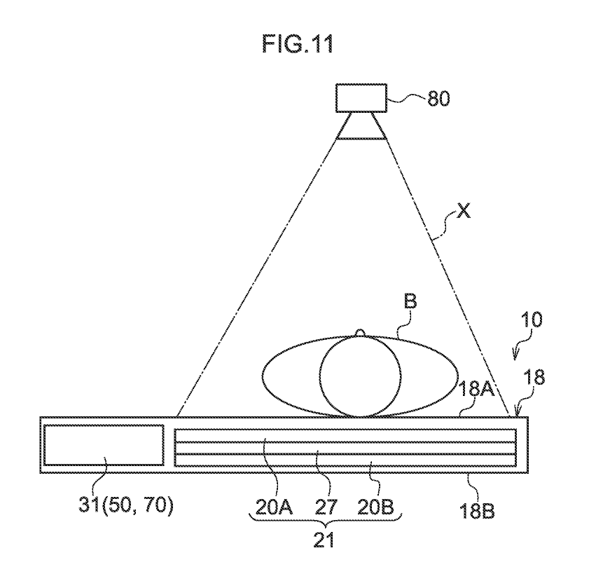

FIG. 10 shows a perspective view of a configuration of the electronic cassette 10, and FIG. 11 shows a cross-sectional view of the electronic cassette 10.

The electronic cassette 10 is equipped with a flat plate shaped casing 18 formed from a material that allows radiation X to pass through, and having a structure that is waterproof and tightly sealed. The above-described image capture section 21 is disposed inside the casing 18. Flat plate shaped faces on one face and the other face of the casing 18 corresponding to the placement position of the image capture section 21 configure image capture regions 18A, 18B onto which radiation is irradiated during image capture. The image capture section 21 is installed in the casing 18 such that the radiation detector 20A is on the image capture region 18A side, between the light blocking plate 27 and the image capture region 18A. The image capture region 18A is an image capture region of image quality focused, and the image capture region 18B is an image capture region of sensitivity focused.

A case 31, housing a controller 50 and a power source section 70 described below, is disposed at a position at one end inside the casing 18 so as not to overlap with the radiation detector 20 (outside the range of the image capture regions 18A, 18B). In order to configure the electronic cassette 10 capable of performing radiographic image capture from both sides through the image capture regions 18A, 18B, components that would affect the radiographic images, such as circuits and elements, are not disposed within the image capture regions 18A, 18B.

The electronic cassette 10 is provided with an operation panel 19, equipped with various buttons, on a side face of the casing 18.

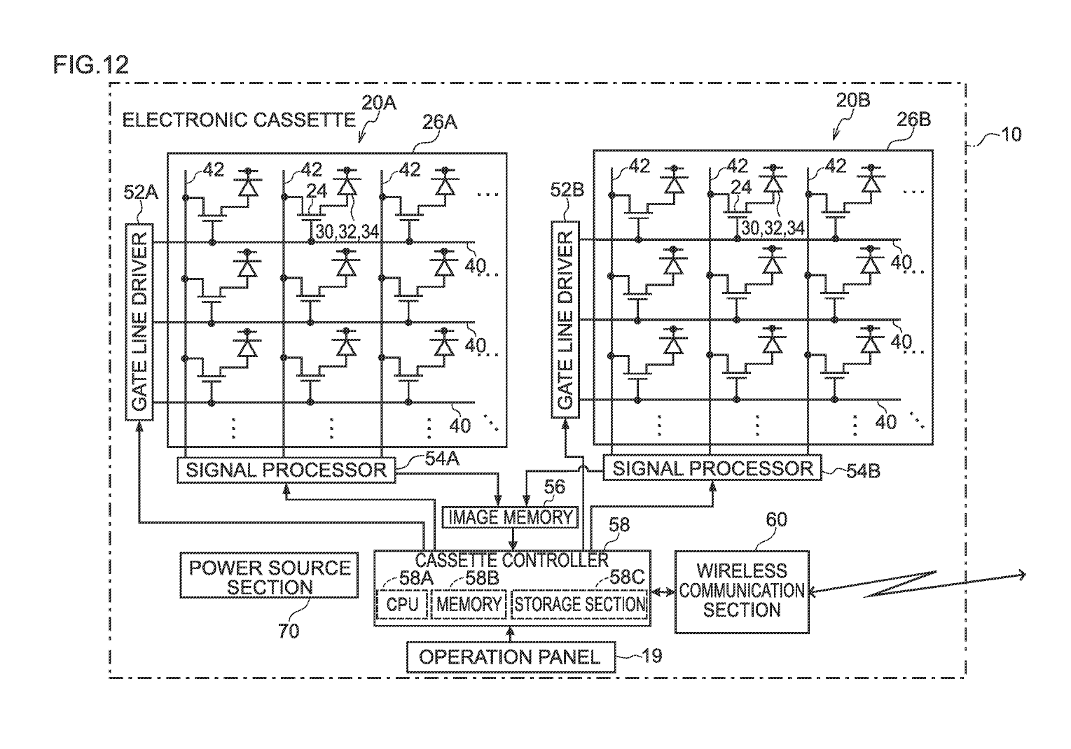

FIG. 12 is a block diagram showing main portions of the electrical system of the electronic cassette 10.

The radiation detectors 20A, 20B have gate line drivers 52A, 52B disposed respectively on one side of two adjacent sides, and have signal processors 54A, 54B disposed respectively on the other of the two adjacent sides. Each gate lines 40 of the radiation detector 20A are connected to the gate line driver 52A, and each data lines 42 of the radiation detector 20A are connected to the signal processor 54A. Each gate lines 40 of the radiation detector 20B are connected to the gate line driver 52B and each data lines 42 of the radiation detector 20B are connected to the signal processor 54B.

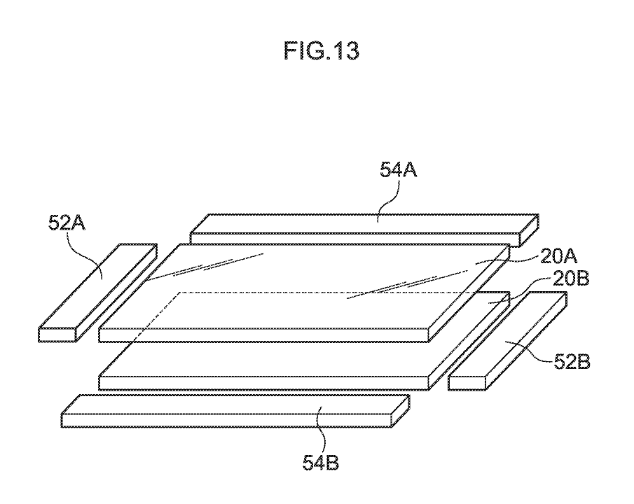

Since the gate line drivers 52A, 52B and the signal processors 54A, 54B generate heat, when stacking the radiation detectors 20A, 20B, as shown in FIG. 13, in order to suppress the influence on each other from heat, preferably one of the radiation detectors 20A, 20B is rotated with respect to the other such that the gate line driver 52A, the gate line driver 52B, the signal processor 54A and the signal processor 54B are disposed without being superimposed on each other.

An image memory 56, a cassette controller 58 and a wireless communication section 60 are disposed as the controller 50 within the casing 18.

Each of the switch elements 24 of the TFT substrates 26A, 26B is switched ON in sequence in row units due to a signal supplied from the gate line drivers 52A, 52B through the gate lines 40. The charge read from the switch elements 24 that are switched ON is transmitted as an electrical signal by the data lines 42 and input to the signal processors 54A, 54B. Thus, charge is read in sequence in row units and a two-dimensional radiographic image is acquired.

While not shown in the figures, the signal processors 54A, 54B are provided with an amplification circuit and a sample and hold circuit for every data lines 42 for amplifying the input electrical signal. After the electrical signal transmitted by the individual data lines 42 has been amplified by the amplification circuit, the electrical signal is held in the sample and hold circuit. The output sides of the sample and hold circuits are connected in sequence to a multiplexer and an analogue/digital (A/D) converter, and the electrical signals held in the individual sample and hold circuits are input in sequence (serially) to the multiplexer and converted into digital image data using the A/D converter.

The image memory 56 is connected to the signal processors 54A, 54B, and image data that has been output from the A/D converters of the signal processors 54A, 54B is stored in sequence in the image memory 56. The image memory 56 has storage capacity capable of storing a specific number of frames worth of image data, and every time radiographic image capture is performed, image data obtained by the image capture is stored in sequence in the image memory 56.

The image memory 56 is connected to the cassette controller 58. The cassette controller 58 is configured by a microcomputer and is provided with a central processor unit (CPU) 58A, a memory 58B including read only memory (ROM) and random access memory (RAM), and a nonvolatile storage section 58C configured from flash memory or the like. The cassette controller 58 controls overall operation of the electronic cassette 10.

The wireless communication section 60 is connected to the cassette controller 58. The wireless communication section 60 conforms to a wireless local area network (LAN) standard, as typified by the Institute of Electrical and Electronics Engineers (IEEE) standards 802.11 a/b/g of the like, and controls transmission of various data by wireless communication between to and from an external device. The cassette controller 58 is capable of wireless communication through the wireless communication section 60 with an external device for controlling radiographic image capture overall, such as a console, so as to enable various data to be transmitted and received to and from the console.

The cassette controller 58 can separately control the operation of the gate line drivers 52A, 52B, and can separately read image data expressing radiographic images from the radiation detectors 20A, 20B. The cassette controller 58 stores various data such as, for example, image capture conditions and the like, received from the console through the wireless communication section 60, and controls the gate line drivers 52A, 52B according to the image capture conditions so as to perform image reading from the radiation detectors 20A, 20B.

The cassette controller 58 is connected to the operation panel 19, and can ascertain operations performed on the operation panel 19.

The power source section 70 is provided in the electronic cassette 10 and the various circuits and various elements described above (such as, for example, the operation panel 19, the gate line drivers 52A, 52B, the signal processors 54A, 54B, the image memory 56, a micro computer that functions as the wireless communication section 60 and the cassette controller 58) are operated by power that has been supplied from the power source section 70. The power source section 70 has a battery installed (a rechargeable battery capable of recharging) so that the portability of the electronic cassette 10 is not compromised, and power is supplied from the charged battery to the various circuits and elements. Wiring connecting the power source section 70 to the various circuits and various elements is omitted in FIG. 12.

Explanation now follows regarding the operation of the electronic cassette 10 according to the present exemplary embodiment.

The electronic cassette 10 according to the present exemplary embodiment is configured capable of image capture with one of the radiation detectors 20A, 20B alone, or of image capture with both of the radiation detectors 20A, 20B.

In image capturing with both of the radiation detectors 20A, 20B, it is also capable of generating energy subtraction images by performing image processing of weighted addition of each of the corresponding pixels in the radiographic images captured by the respective radiation detectors 20A, 20B.

Further, the electronic cassette 10 is capable of separately saving image information (data) expressing radiographic images captured by the respective radiation detectors 20A, 20B, and image information (data) of a generated energy subtraction image.

In order to perform radiographic image capture, an operator may specify on a console, according to the application, type of image to be captured from among image quality focused image, sensitivity focused image, or an energy subtraction image. In a case in which energy subtraction image has been specified as the image to be captured, the operator may specify on the console whether or not image processing should be executed in the electronic cassette 10 for generating the energy subtraction image. The operator may also specify on the console whether or not image data captured in the electronic cassette 10 should be saved.

The console transmits to the electronic cassette 10, as processing conditions, the specified image to be captured, execution/non-execution of image processing for generating an energy subtraction image, and execution/non-execution of image data saving.

The electronic cassette 10 stores the transmitted processing conditions in the storage section 58C.

The electronic cassette 10 is provided with the image capture region 18A focused on image quality and the image capture region 18B focused on sensitivity, and is capable of capturing radiographic image by either the image capture region 18A or the image capture region 18B by flipping over the whole electronic cassette 10.

The electronic cassette 10 is disposed with the image capture region 18A upwards when performing image capture of an image quality focused image and/or an energy subtraction image, and with the image capture region 18B upwards when performing image capture of a sensitivity focused image. As shown in FIG. 11, the electronic cassette 10 is disposed with a separation to a radiation generation device 80, and an imaging target location B of a patient is placed on the imaging region. The radiation generation device 80 emits radiation of a radiation amount in accordance with the pre-specified image capture conditions and the like. Radiation X emitted from the radiation generation device 80 passes through the imaging target location B, and the passed radiation X thereby carrying image information is irradiated onto the electronic cassette 10.

Thus, the radiation X irradiated from the radiation generation device 80 arrives at the electronic cassette 10 after passing through the imaging target location B. Accordingly, charge is collected and stored in each of the charge collecting electrodes 34 of the radiation detector 20 installed in the electronic cassette 10 according to the radiation amount of the radiation X irradiated thereon.

After irradiation of the radiation X finishes, the cassette controller 58 performs image reading processing to read the image according to the processing conditions stored in the storage section 58C.

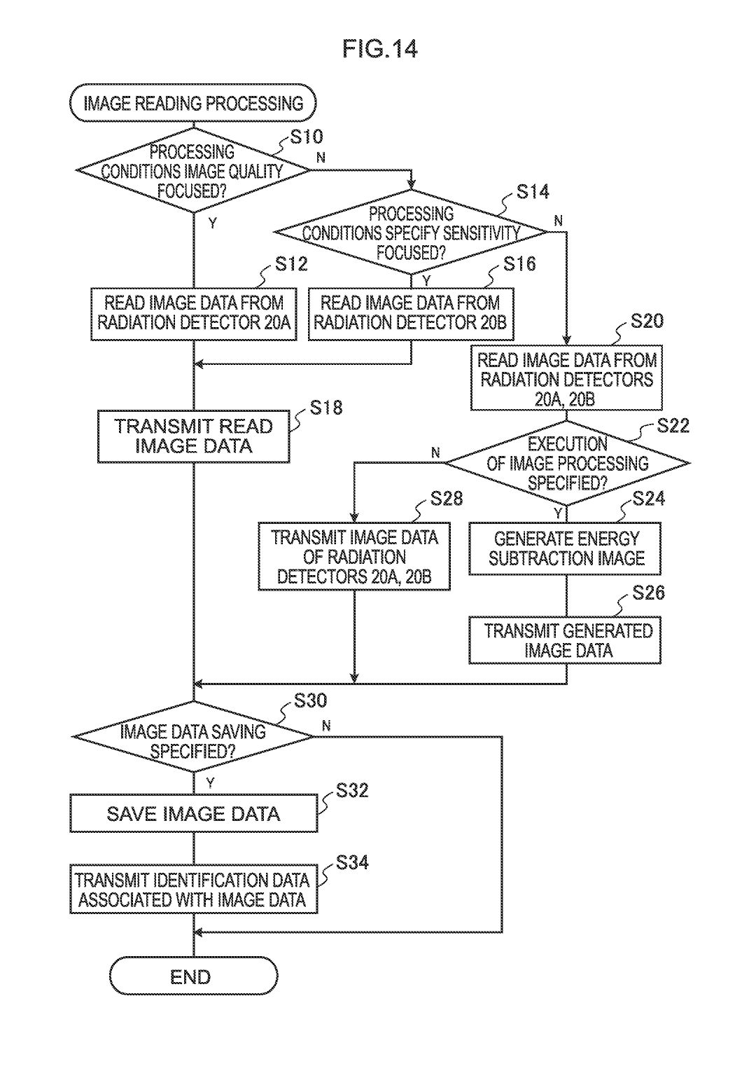

FIG. 14 is a flow chart showing a flow of an image reading processing program executed by the CPU 58A. Note that the program may be pre-stored in a specific region of ROM in the memory 58B.

At step S10, determination is made as to whether or not image capture specified by the processing conditions is image quality focused capture. If affirmative determination is made processing proceeds to step S12, and if negative determination is made processing proceeds to step S14.

At step S12, image data reading is performed by controlling the gate line driver 52A such that an ON signal is output from the gate line driver 52A in sequence one line at a time to the gate lines 40 of the radiation detector 20A which is image quality focused. The image information (data) read from the radiation detector 20A is stored in the image memory 56.

At step S14, determination is made as to whether or not image capture specified in the processing conditions is sensitivity focused capture. If affirmative determination is made processing proceeds to step S16, and if negative determination is made processing proceeds to step S20.

At step S16, image data reading is performed by controlling the gate line driver 52B such that an ON signal is output from the gate line driver 52B in sequence one line at a time to the gate lines 40 of the radiation detector 20B which is sensitivity focused. The image information (data) read from the radiation detector 20B is stored in the image memory 56.

At step S18, the image data stored in the image memory 56 is transmitted to the console.

Accordingly, image data of a radiographic image captured with image quality focused characteristics by the radiation detector 20A, or image data of a radiographic image captured with sensitivity focused characteristics by the radiation detector 20B is transmitted to the console.

At step S20, image data reading is performed for energy subtraction image according to the specification of the processing conditions, by controlling the gate line drivers 52A, 52B such that an ON signal is output in sequence one line at a time to the gate lines 40 of the radiation detectors 20A, 20B. The image information (data) read from the radiation detectors 20A, 20B is stored in the image memory 56.

At step S22, determination is made as to whether or not execution of image processing for generating an energy subtraction image is specified in the processing conditions. When affirmative determination is made processing proceeds to step S24, and when negative determination is made processing proceeds to step S28.

At step S24, weighted addition is performed for each of the corresponding pixels in the radiographic images on the image data stored in the image memory 56 from the radiation detectors 20A, 20B, and an energy subtraction image is generated.

Then, at step S26, the image data of the generated energy subtraction image is transmitted to the console.

At step S28, the image data obtained from the radiation detectors 20A, 20B stored in the image memory 56 is transmitted to the console. The console can generate an energy subtraction image by performing weighted addition for each of the corresponding pixels in the radiographic images on the transmitted image data obtained at the radiation detectors 20A, 20B. The console can also obtain image data of a radiographic image captured with image quality focused characteristics by the radiation detector 20A, and image data of a radiographic image captured with sensitivity focused characteristics by the radiation detector 20B.

At step S30, determination is made as to whether or not saving of the image data is specified in the processing conditions. If affirmative determination is made processing proceeds to step S32, and processing is ended if negative determination is made.

At step S32, the image data read at step S12, step S16 or step S20 is stored in the storage section 58C with identification information (data) for identifying the image data being attached.

At step S34, the identification data attached to the image data at step S32 is transmitted to the console and processing ended.

The console stores the transmitted identification data, and transmits the identification data to the electronic cassette 10 in a case in which reading of the image data stored in the electronic cassette 10 is desired.

In response to receipt of the identification data transmitted from the console, the electronic cassette 10 reads the image data corresponding to the identification data from the storage section 58C, and transmits the image data to the console.

Reacquisition can accordingly be made of image data of the radiographic images captured in the electronic cassette 10.

The electronic cassette 10 may be configured to save the image data in the storage section 58C until, for example, a specific period has elapsed, or until the next image capturing will be performed and it is preferable that the console being notified of the saving period.

The electronic cassette 10 according to the present exemplary embodiment can thus capture image quality focused radiographic images, sensitivity focused radiographic images, and energy subtraction images, and thereby allows multiple applications.

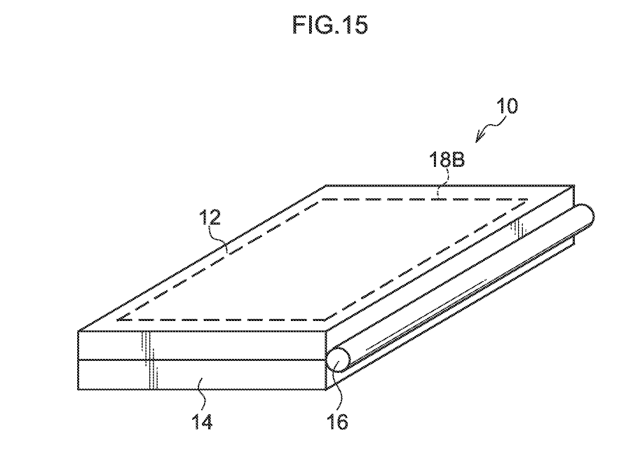

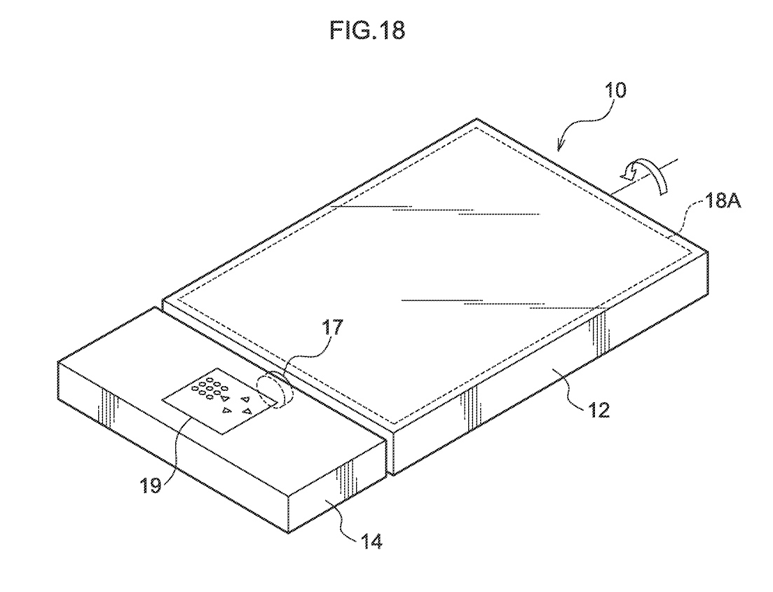

As described above, the electronic cassette 10 of the present exemplary embodiment is configured capable of image capture from both faces, the image capture region 18A or the image capture region 18B, by flipping the whole cassette over. Alternately, the electronic cassette 10 may be configured openable as shown in FIG. 15 to FIG. 17, or configured such that a portion thereof can be inverted as shown in FIG. 18 to FIG. 20.

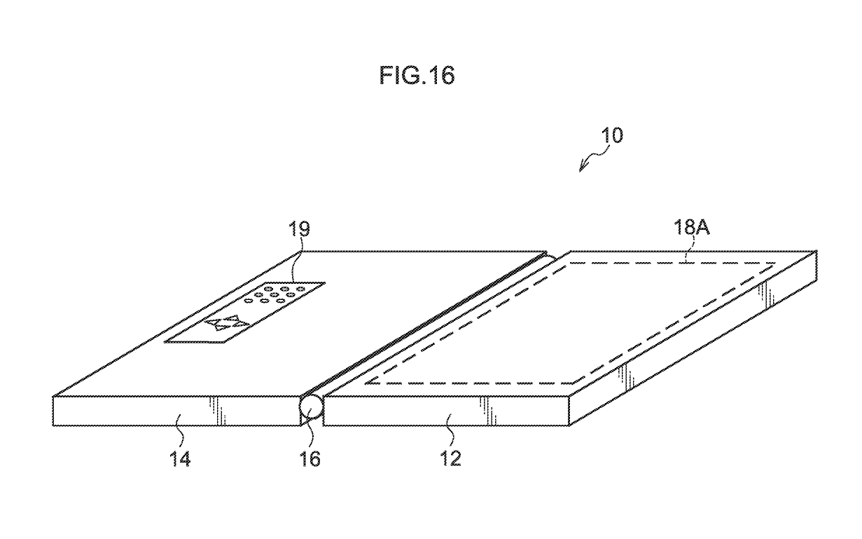

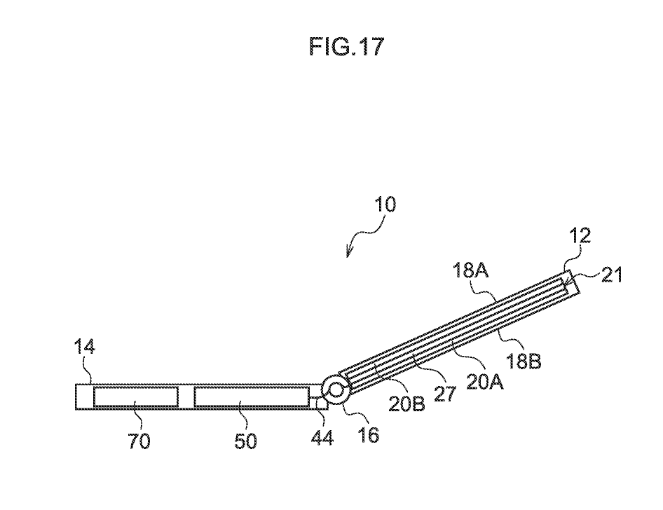

FIG. 15 and FIG. 16 show perspective views of above-described another configuration of the electronic cassette 10, and FIG. 17 shows a cross-sectional view of a schematic configuration of this electronic cassette 10. Portions thereof corresponding to the electronic cassette 10 of the first exemplary embodiment (see FIG. 10 to FIG. 11) have been appended with the same reference numerals, and further explanation of portions having the same function is omitted.

In the electronic cassette 10 of FIGS. 15 to 17, a flat plate shaped image capture unit 12 for capturing radiographic images is connected to a control unit 14 by a hinge 16 in an openable and closable configuration. The image capture unit 12 is installed with the image capture section 21, the gate line drivers 52A, 52B, the signal processors 54A, 54B, and the like, and the control unit 14 is installed with the controller 50 and the power source section 70.

By rotating around the hinge 16 with respect to one other, the image capture unit 12 and the control unit 14 can be opened and closed to attain an opened state (FIG. 16) in which the image capture unit 12 and the control unit 14 are side-by-side, and a folded (stored) state (FIG. 15) in which the image capture unit 12 and the control unit 14 are folded together and superimposed on top of each other.

An operation panel 19 is provided to the top face of the control unit 14 in the electronic cassette 10.

The image capture section 21 of this modified configuration is installed in the image capture unit 12, as shown in FIG. 17, such that when in the folded state the radiation detector 20B is positioned at the control unit 14 side, and the radiation detector 20A is positioned at the outer side (the opposite side of the control unit 14). The image capture region 18B which is sensitivity focused is provided at the face at the outside in the folded state configures, and the image capture region 18A which is image quality focused is provided at the face facing the control unit 14 (FIG. 16).

The image capture section 21 is connected to the controller 50 and the power source section 70 by connection wiring 44 provided inside the hinge 16.

Accordingly, image capture either through the image capture region 18A or the image capture region 18B can be performed by opening or closing the electronic cassette 10, whereby radiographic images with different characteristics can be readily captured.

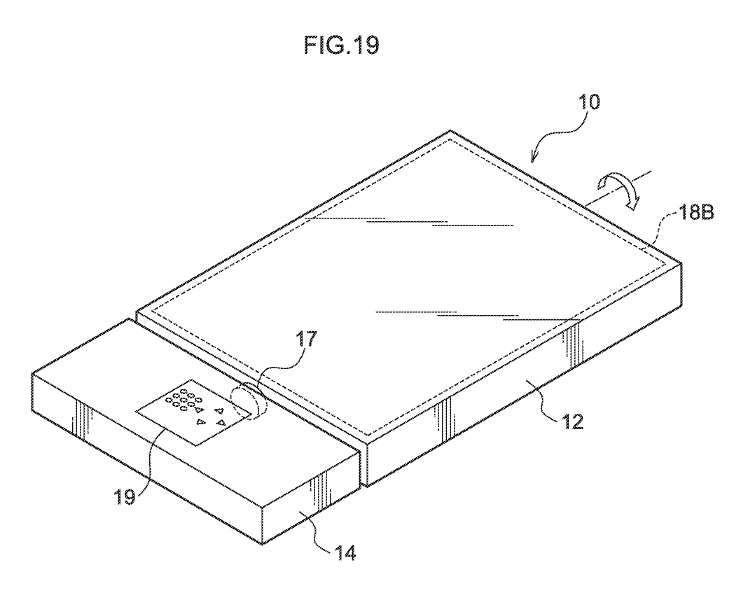

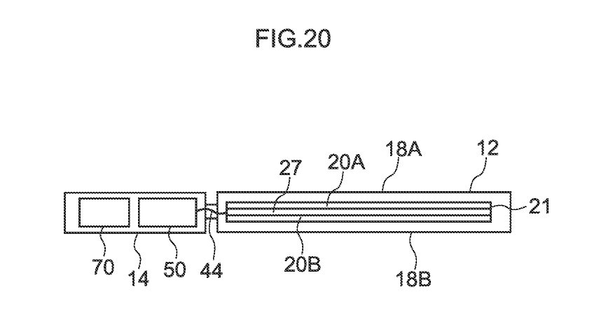

FIG. 18 and FIG. 19 are perspective views showing a configuration of above-described yet another configuration of the electronic cassette 10, and FIG. 20 shows a cross-sectional view of a schematic configuration of this electronic cassette 10. Portions thereof corresponding to the electronic cassette 10 already described (see FIG. 10 to FIG. 17) are appended with the same reference numerals, and further explanation is omitted of portions having the same function.

In the electronic cassette 10 of FIGS. 18 to 20, a flat plate shaped image capture unit 12 for capturing radiographic images is rotatably connected to a control unit 14 by a rotating shaft 17. The image capture unit 12 is installed with the image capture section 21, the gate line drivers 52A, 52B, the signal processors 54A, 54B, and the like, and the control unit 14 is installed with the controller 50 and the power source section 70.

The image capture regions 18A, 18B are provided on two opposite faces of the image capture unit 12, corresponding to the position of the image capture section 21 installed inside.

An operation panel 19 is provided on the top face of the control unit 14 in the electronic cassette 10.

The image capture section 21 is installed such that the radiation detector 20B is positioned at the image capture region 18B side, and the radiation detector 20A is positioned at the image capture region 18A side. The image capture region 18B is configured as a sensitivity focused image capture region, and the image capture region 18A is configured as an image quality focused image capture region.

The image capture section 21 is connected to the controller 50 and the power source section 70 by connection wiring 44 provided inside the rotating shaft 17.

By rotating one of the image capture unit 12 and the control unit 14 with respect to the other, the electronic cassette 10 can be set in a side-by-side state of the image capture region 18A and the operation panel 19 (FIG. 18) and a side-by-side state of the image capture region 18B and the operation panel 19 (FIG. 19).

Accordingly, image capture of radiographic images with different characteristics can be readily performed through the image capture region 18A or the image capture region 18B by rotating the electronic cassette 10.

### Second Exemplary Embodiment

Since the configuration of the electronic cassette 10 according to the second exemplary embodiment is similar to that of the first exemplary embodiment (shown in FIG. 1 to FIG. 4), only the portions that differ will be explained, and further explanation of similar portions will be omitted.

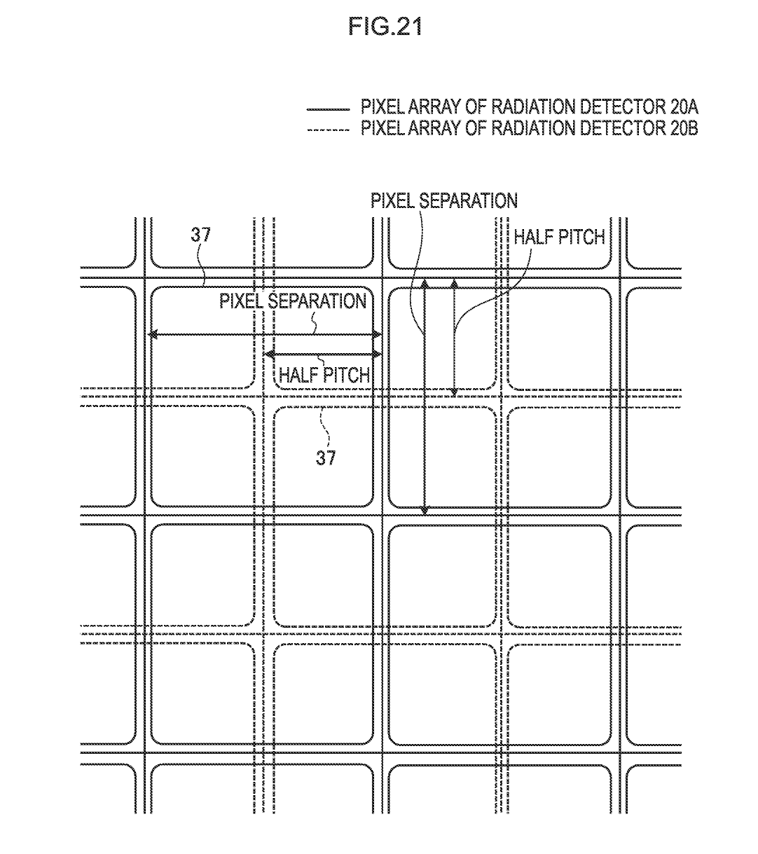

Similarly to the first exemplary embodiment, an image capture section 21 according to the second exemplary embodiment is configured with two radiation detectors 20A, 20B disposed with their scintillator layer 28 sides facing each other and on either side of a light blocking plate 27 (see FIG. 7). Further, as shown in FIG. 21, the radiation detectors 20A, 20B are disposed such that pixels 37, which are respectively provided in a two-dimensional pattern in the radiation detectors 20A, 20B, are relatively displaced by half the pitch of the pixels 37 in both one direction (the row direction) and direction intersecting therewith (the column direction). Note that in FIG. 21 the pixel array of the radiation detector 20A is shown with solid lines and the pixel array of the radiation detector 20B is shown with dashed lines.

In the image capture section 21 according to the second exemplary embodiment, the thicknesses, particle diameters, multi-layer structure of the particles, fill rate of the particles, doping amount of additives, materials, layer structure and the like of the scintillator layers 28A, 28B are adjusted such that the characteristics of the radiographic images captured with the radiation detectors 20A, 20B are substantially the same as each other when radiation is irradiated from the image capture region 18A side.

Explanation now follows regarding operation of the electronic cassette 10 according to the present exemplary embodiment.

In the electronic cassette 10 according to the second exemplary embodiment as well, it is possible to capture radiographic images with one of the radiation detectors 20A, 20B alone, or to capture radiographic images with both the radiation detectors 20A, 20B.

In a case in which image capture is performed with both of the radiation detectors 20A, 20B, it is possible to generated a high resolution radiographic image in which the resolution is raised by performing interpolation processing with the radiographic images captured by the respective radiation detectors 20A, 20B.

Further, the electronic cassette 10 is capable of separately saving image data expressing radiographic images captured by the respective radiation detectors 20A, 20B, and image data of a generated high resolution radiographic image.

The electronic cassette 10 according to the second exemplary embodiment is disposed with the image capture region 18A upwards when capturing radiographic images, as shown in FIG. 11, with a separation to the radiation generation device 80 that generates radiation, and with an imaging target location B of a patient disposed above the image capture region.

When performing radiographic image capture, an operator may specify on a console, according to the application, image capture of a standard image to be employed in normal diagnostics or a high resolution image to be employed in a precision investigation. When conditions of the image to be captured (image conditions) have been specified, the console transmits image condition data expressing the specified image conditions to the electronic cassette 10. When a high resolution image is specified, the operator may specify on the console whether or not image processing for generating a high resolution image is to be executed in the electronic cassette 10. The operator may also specify on the console whether or not to execute saving of the captured image data in the electronic cassette 10.

The console transmits to the electronic cassette 10, as processing conditions, the specified image for capture, whether or not image processing for generating a high resolution image is to be executed, and whether or not saving of image data is to be execute.

The electronic cassette 10 stores the transmitted processing conditions in the storage section 58C.

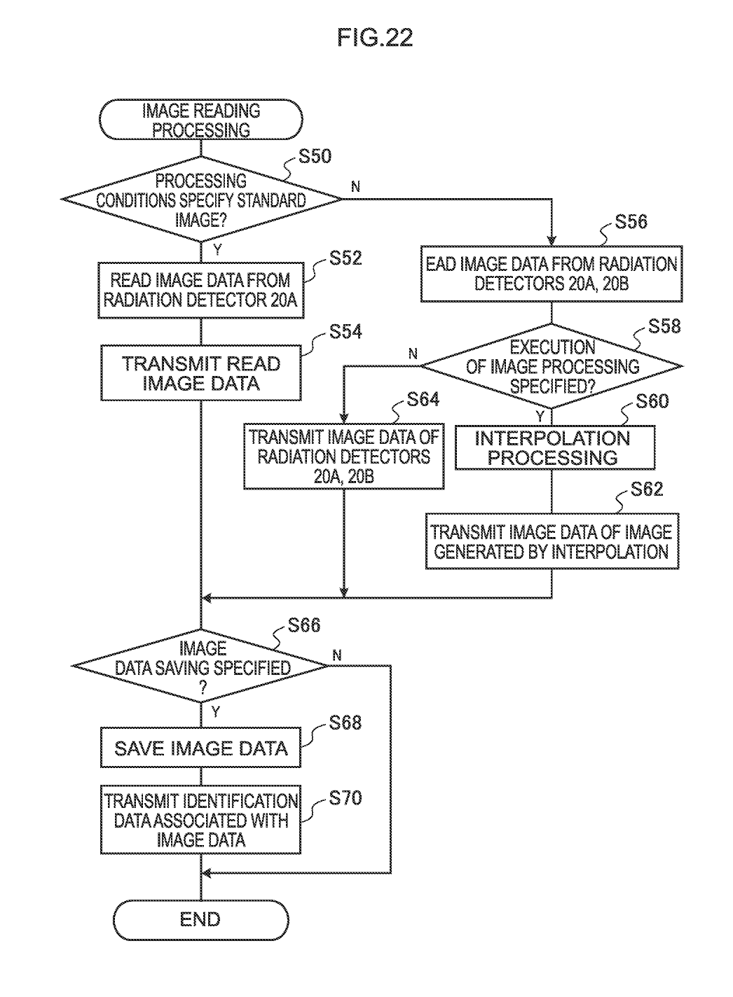

FIG. 22 shows a flow chart of an image reading processing program according to the second exemplary embodiment.

At step S50, determination is made as to whether or not the image for capture specified in the processing conditions is a standard image. When affirmative determination is made processing proceeds to step S52, and when negative determination is made processing proceeds to step S56.

At step S52, image data reading is performed by controlling the gate line driver 52A such that an ON signal is output from the gate line driver 52A in sequence one line at a time to the gate lines 40 of the radiation detector 20A having image quality focused characteristics. The image information (data) read from the radiation detector 20A is stored in the image memory 56.

At step S54, the image data stored in the image memory 56 is transmitted to the console.

Accordingly, image data of a radiographic image captured with the radiation detector 20A is transmitted to the console.

At step S56, image data reading is performed for high resolution image as specified in the processing conditions by controlling both the gate line drivers 52A, 52B such that an ON signal is output in sequence one line at a time to the gate lines 40 of the radiation detectors 20A, 20B. The image information (data) read from the radiation detectors 20A, 20B is stored in the image memory 56.

At step S58, determination is made as to whether or not execution of image processing for generating a high resolution image is specified in the processing conditions. When affirmative determination is made processing proceeds to step S60, and when negative determination is made processing proceeds to step S64.

At step S60, a high resolution radiographic image having a half pixel pitch of the original radiographic images is generated by deriving each pixel values thereof by performing interpolation processing on the pixel values of each pixel in the image data obtained at the radiation detectors 20A, 20B and stored in the image memory 56.

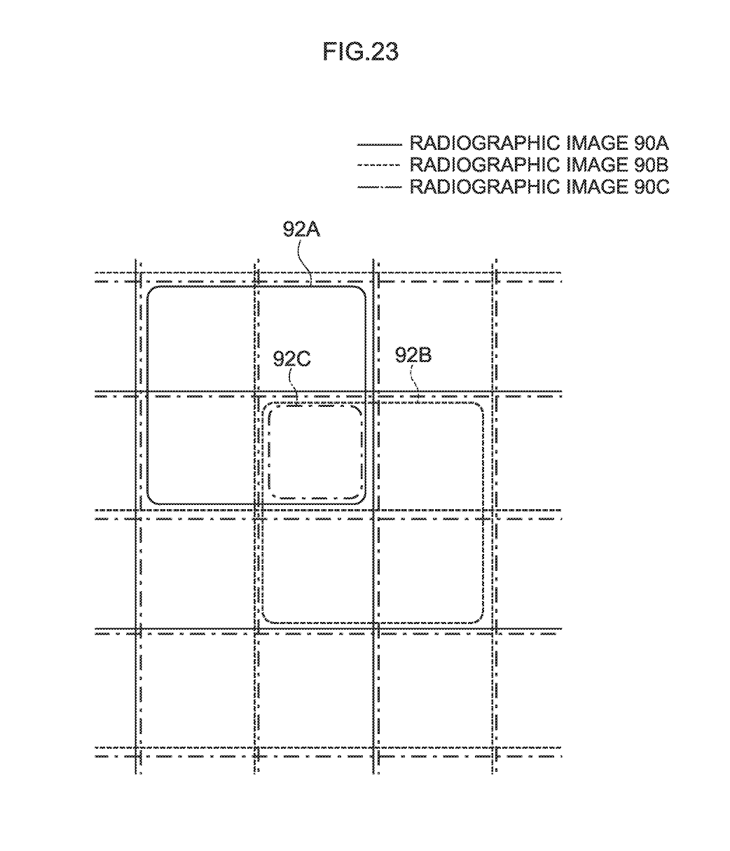

FIG. 23 shows an example of interpolation processing. FIG. 23 shows a pixel array of a radiographic image 90A captured by the radiation detector 20A as solid lines, shows a pixel array of a radiographic image 90B captured by the radiation detector 20B as dashed lines, and shows a pixel array of a high resolution radiographic image 90C for generation by single dot intermittent lines.

In the present exemplary embodiment, the arrays of the pixels 37 of the radiation detectors 20A, 20B are disposed displaced relative to each other by half the pitch of the pixel separation in one direction (the row direction) and a direction intersecting therewith (the column direction). Accordingly, the pixel array of the radiographic image 90A (solid lines) and the pixel array of the radiographic image 90B (dashed line) are displaced by half the pitch of the pixel separation with respect to each other. In the present exemplary embodiment, regions in which a pixel 92A of the radiographic image 90A and a pixel 92B of the radiographic image 90B are superimposed on each other configure a pixel 92C of the high resolution radiographic image 90C, and image data of a high resolution radiographic image is generated such that the pixel value C of the pixel 92C is obtained as the arithmetic average of the pixel values A, B of the pixels 92A, and 92B, i.e., C=(A+B)/2.

At step S62, the image data of the generated high resolution image is transmitted to the console.

At step S64, the image data obtained at the radiation detectors 20A, 20B and stored in the image memory 56 is transmitted to the console. The console can generate a high resolution image by performing image processing for generating a high resolution image on the transmitted image data obtained by the radiation detectors 20A, 20B. The console can also obtain image data of a standard radiographic image captured by the radiation detectors 20A, 20B.

At step S66, determination is made as to whether or not saving of the image data is specified in the processing conditions. When affirmative determination is made processing proceeds to step S68, and processing is ended when negative determination is made.

At step S68, the image data read at step S52 or step S56 is stored in the storage section 58C with identification information (data) for identifying the image data being attached thereto.

At step S70, the identification data attached to the image data at step S68 is transmitted to the console and processing ended.

Thus, the electronic cassette 10 according to the second exemplary embodiment can capture radiographic images with varied resolution, thereby allows multiple applications.

In general, when attempting to obtain high resolution images with a single panel of radiation detector 20, the yield of the radiation detectors 20 falls since the pixel array of such radiation detectors 20 must be made finer.

In contrast, in the present exemplary embodiment, since a high resolution radiographic image is generated using two panels of the radiation detectors 20A, 20B, the pixel array of the radiation detectors 20A, 20B does not need to be made finer and good yield can be achieved.

Explanation has been given of the present invention by way of exemplary embodiments, however the technical scope of the present invention is not limited to the range described in the above exemplary embodiments. Various changes and improvements can be made to the above exemplary embodiments within a scope not departing from the spirit of the invention, and the technical scope of the present invention also includes such changed and improved embodiments.

The above exemplary embodiments do not limit the invention according to the claims, and all of the combination of features explained in the exemplary embodiments above are not necessarily essential to the solution of the present invention. Various levels of invention are included in the above embodiments, and various inventions can be derived by appropriate combinations of plural of the configuration elements described. A number of configuration elements from out of the total configuration elements shown in the exemplary embodiments may be removed, and as long as an effect is obtained, the configuration from which a number of configuration elements have been removed is derivable as the invention.

For example, explanation has been given in the above exemplary embodiments to a case in which application is made to the electronic cassette 10 as a portable radiographic image capturing device, however embodiments are not limited thereto, and application may be made to a fixed radiographic image capturing device.

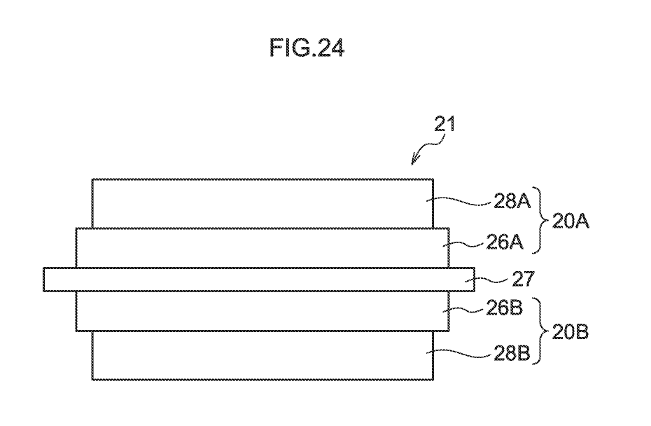

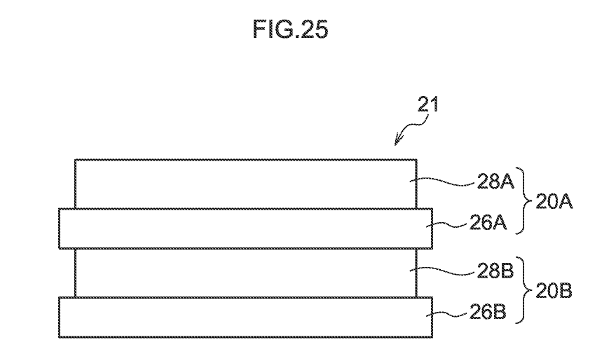

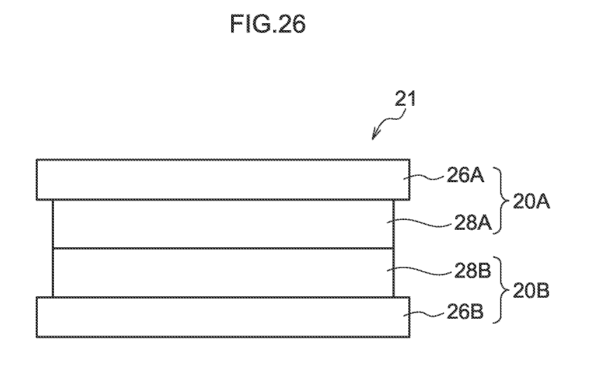

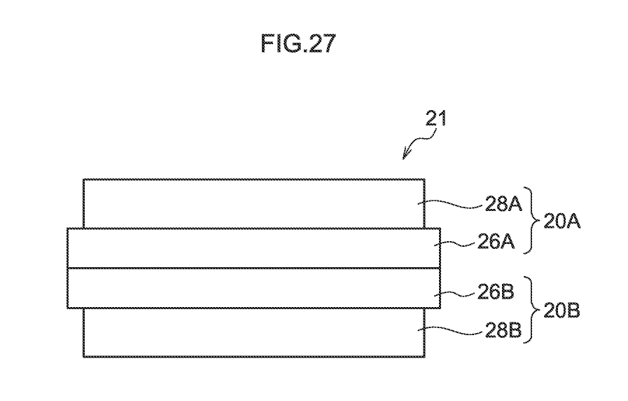

Explanation is given in the above exemplary embodiments of cases in which the image capture section 21 is configured, as shown in FIG. 7, with the two radiation detectors 20A, 20B disposed such that the respective scintillator layers 28A, 28B sides thereof face each other on either side of the light blocking plate 27 that permits radiation to pass through but shields light, however there is not limited thereto. For example, as shown in FIG. 24, the image capture section 21 may be configured with the two radiation detectors 20A, 20B disposed such that the respective TFT substrates 26A, 26B are facing each other on either side of the light blocking plate 27. Alternately, for example as shown in FIG. 25, the radiation detectors 20A, 20B may be stacked such that their TFT substrates 26 and scintillator layers 28 are facing in the same direction. Further alternately, for example as shown in FIG. 26, the radiation detectors 20A, 20B may be stacked such that both are irradiated with back face irradiation, or, as shown in FIG. 27, the radiation detectors 20A, 20B may be stacked such that both are irradiated with front face irradiation.

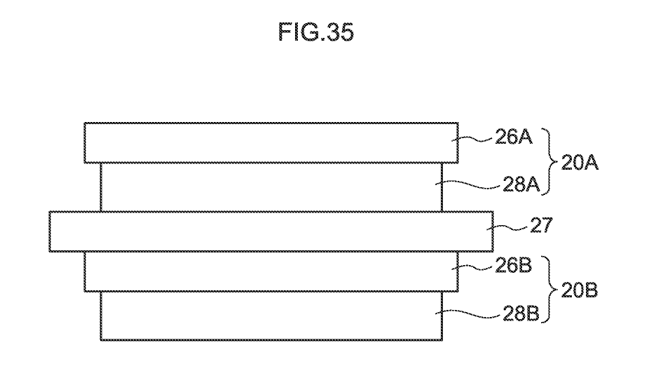

Alternately, as shown in FIG. 35, the radiographic image capturing device may be configured such that being irradiated radiation from one side thereof, the two radiation detectors 20A, 20B are stacked such that the respective TFT substrates 26 and scintillator layers 28 are disposed in this order from the radiation irradiated side, and the light blocking plate 27 is disposed between the radiation detectors 20A, 20B. In this configuration, both of the radiation detectors 20A, 20B are used in back face irradiation (ISS) method. Further, in this configuration, the scintillator layer 28A of at least one of the two radiation detectors 20A, 20B that is disposed at the radiation irradiated side (the radiation detector 20A) may include an organic material such as CsI.

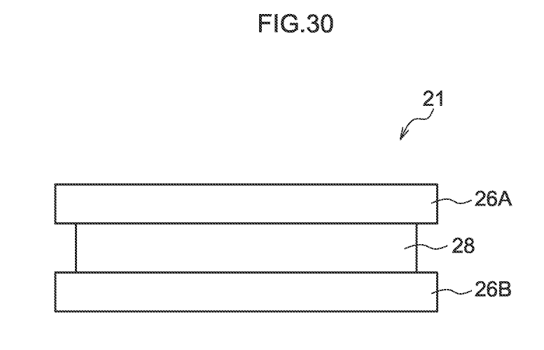

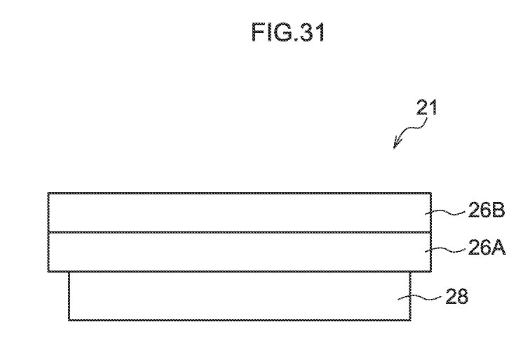

Furthermore, as shown in FIG. 30 for example, two TFT substrates 26A, 26B may be provided, and a TFT substrate 26A may be disposed on the face at one side of a scintillator layer 28, and a TFT substrate 26B may be disposed at the face on the other side of the scintillator layer 28. Or, as shown in FIG. 31 for example, a scintillator layer 28 may be disposed on one side of a TFT substrate 26A, and a TFT substrate 26B may be disposed on the other side of the TFT substrate 26A.

In the above exemplary embodiments, explanation of cases in which the two radiation detectors 20A, 20B are disposed on either side of the light blocking plate 27 that permits radiation to pass but shields light, however there is no limitation thereto. For example, in a case in which image capturing is configured to be performed at the both faces of the image capture regions 18A, 18B, the light blocking plate 27 may be configured to shield radiation. Or, the light blocking plate 27 may be a light blocking plate that is rigid that can support the radiation detectors 20A, 20B. If the light blocking plate 27 is configured with a rigid light blocking plate, since each of the TFTs can be formed on the light blocking plate, an insulating substrate (in practice a glass layer) on which the TFTs are formed becomes unnecessary, and a reduction in weight can be achieved due to omitting two insulating substrates. In such cases, since a flexible type of light generation layer and TFT can be formed on the light blocking substrate, the TFT may be disposed between the light blocking substrate and the light generation layer.

The second exemplary embodiment has been described as a case in which the pixel arrays of the radiation detectors 20A, 20B are displaced with respect to each other, however there is no limitation thereto. For example, the pixel arrays of the radiation detectors 20A, 20B may be aligned with each other, and a radiographic image may be generated by averaging corresponding pixels in the radiographic images captured by the radiation detectors 20A, 20B, thereby reducing noise included in the resultant radiographic image.

Furthermore, while in each of the exemplary embodiments, explanation is of cases in which images are not read from the image capture system not specified in the image conditions, there is no limitation thereto. For example, in the configuration of the first exemplary embodiment, images may be read from both the radiation detectors 20A, 20B regardless of whether the image for capture specified in the processing conditions is image quality focused image or sensitivity focused. In such cases, if the image for capture is an image quality focused image, the image data that has been read from the radiation detector 20B is stored in the storage section 58C and not transmitted to the console, while if the image for capture is a sensitivity focused images, the image data that has been read from the radiation detector 20A is stored in the storage section 58C and not transmitted to the console, and image data stored in the storage section 58C may be transmitted to the console as requested from the console.

In each of the exemplary embodiments, explanation has been given of cases in which the image capture section 21 has two image capture system for performing radiographic image capture expressing irradiated radiation, however there is no limitation thereto. For example, more than two image capture system may be provided by further staking of TFT substrates 26 and scintillator layers 28 in the image capture section 21.

In each of the exemplary embodiments, explanation has been given of cases in which processing conditions for each of the image capture systems of the image capture section 21 are received from the console by the wireless communication section 60 by wireless communication, however there is no limitation thereto. For example, the processing conditions may be input to and received at the operation panel 19.

In the exemplary embodiments, explanation is of cases in which the processing conditions include specifications of: image for capture; whether or not to execute image processing for generating energy subtraction image; whether or not to execute image processing for generating a high resolution image; and whether or not to execute saving of image data. However, there is no limitation thereto. For example, the processing conditions may further include specifications of any one or more of: whether or not to execute read processing of image information (data) from each of the image capture systems of the image capture section 21; whether or not to execute other image processing to image data read from each of the image capture systems; whether or not to execute transmission of image data read from each of the image capture systems or processed image data; and/or whether or not to execute saving of image data read from each of the image capture systems or processed image data.

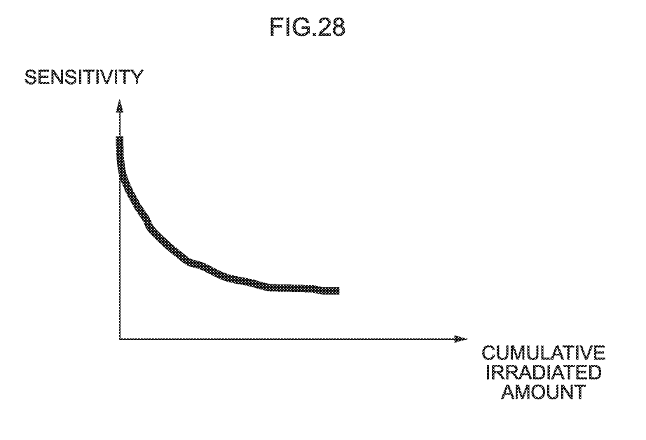

Here, he CsI which can be used to form the scintillator layer, exhibits reduced sensitivity as the cumulative irradiated amount increases during performing successive image capture, and the reduced sensitivity recovers when a state of no radiation irradiation is maintained as shown in FIG. 28.

In the exemplary embodiments, the image capture section 21 having two scintillator layers 28 (28A, 28B), as shown in FIG. 7 and FIG. 24 to FIG. 27, may be configured with scintillator layers 28A, 28B formed with CsI, for example columnar crystals of CsI:Tl and such image capture section 21 may be installed in the electronic cassette 10 such that radiographic image capture at two opposite sides (the image capture regions 18A, 18B) of the electronic cassette 10 is possible. In such cases, the electronic cassette 10 may detect the respective radiation amounts irradiated on the two faces, and store the respective cumulative irradiated amounts for the two faces. When estimated from the cumulative irradiated amount that the sensitivity of the scintillator layer 28 is below a specific tolerable sensitivity at which the image quality of the radiographic images to be captured is affected, the electronic cassette 10 may prohibit image capture with the face at which the estimated sensitivity of the scintillator layer 28 is below the tolerable sensitivity, and prompt an operator to perform image capture with the opposite face. Detection of the radiation amount may be performed by a sensor capable of radiation detection provided inside the electronic cassette 10, or may be performed based on the pixel values of the pixels in the captured radiographic images (for example, the cumulative value of pixel values for all the pixels may be taken as the irradiated radiation amount). Prohibition of image capture with the face at which the sensitivity of the scintillator layer 28 is below the tolerable sensitivity may be notified to the operator through an external device such as the console, or may be achieved by display on a display section or the like provided to the operation panel 19.

The reduced sensitivity of the CsI rapidly recovers by maintaining in a high temperature environment. Further, reduction in the sensitivity of CsI can be suppressed the higher the temperature of the usage environment. Therefore, for example, in an image capture section 21 having two scintillator layers 28 (28A, 28B) as shown in FIG. 7 and FIG. 24 to FIG. 27, one of the layers, the scintillator layer 28A, may be formed with CsI (for example, columnar crystals of CsI:Tl), and the other layer, the scintillator layer 28B, may be formed with GOS. This image capture section 21 may be installed in the openable and closeable electronic cassette 10 shown in FIGS. 15 to 17 and configured capable of image capture of radiographic images from two faces (the image capture regions 18A, 18B). In such cases, the image capture section 21 is preferably installed into the image capture unit 12 such that the scintillator layer 28B is on the control unit 14 side, and the scintillator layer 28A is on the outer side (the opposite side to that of the control unit 14) in the folded state.

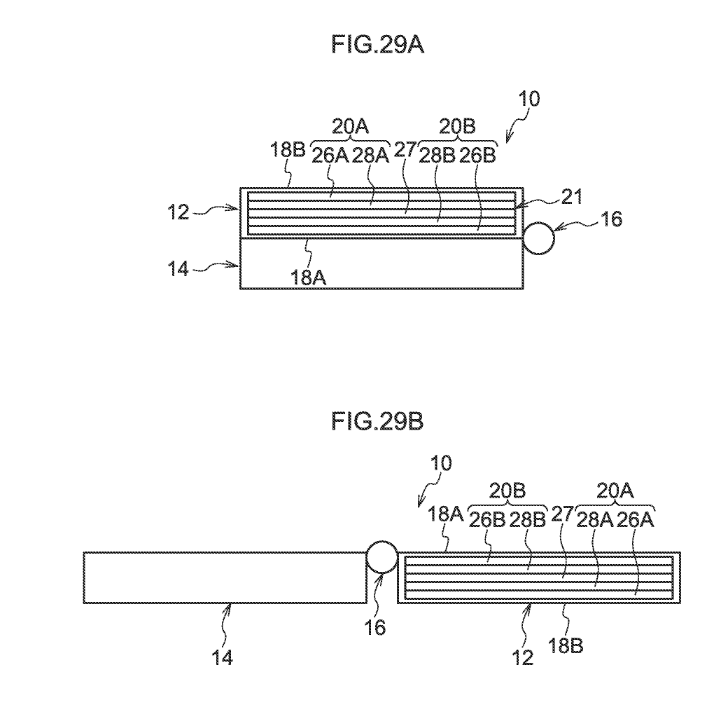

FIGS. 29A and 29B show, for example, a state in which the image capture section 21 shown in FIG. 7 is installed in the openable and closeable electronic cassette 10 shown in FIG. 15 to FIG. 17.

In this electronic cassette 10, heat from the control unit 14 is readily transmitted to the image capture unit 12 in the folded state. Accordingly, reduction in sensitivity of the scintillator layer 28A is suppressed by disposing the scintillator layer 28A on the image capture region 18B side (FIG. 29A) and using the scintillator layer 28A for image capture in the folded state. In contrast, GOS hardly changes in sensitivity with change in temperature. Accordingly, hardly any change in image quality occurs due to changes in sensitivity with temperature fluctuation by disposing the scintillator layer 28B on the image capture region 18A side, and using the scintillator layer 28B for image capture in the open state (FIG. 29B).

Further, in a case in which the scintillator layer 28 is formed with CsI, the change in sensitivity of the scintillator layer 28 may be estimated from the cumulative irradiated amount, and when the estimated sensitivity of the scintillator layer 28 is less than a tolerable sensitivity, the temperature of the scintillator layer 28 is raised and maintained at a higher temperature in order to recover the sensitivity rapidly.

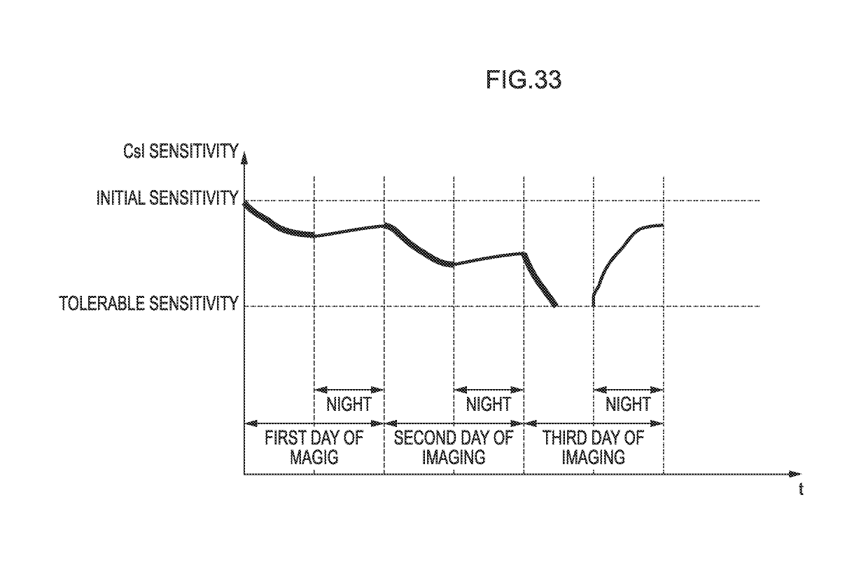

FIG. 33 shows an example of the sensitivity change in a scintillator layer 28A formed with CsI in the electronic cassette 10 as shown in FIG. 29A and FIG. 29B.

In the electronic cassette 10, the sensitivity of the scintillator layer 28A drops due to image capture being performed through the image capture region 18B on the first day of image capture and on the second day of image capture, respectively. However, since a state in which radiation is not irradiated is maintained, the sensitivity of the scintillator layer 28A recovers during the night. The electronic cassette 10, on the third day of image capture, performs fluoroscopic imaging (video imaging) by capturing successive radiographic images with the image capture region 18B, and when the sensitivity of the scintillator layer 28A has become less than a tolerable sensitivity, image capture with the image capture region 18B is prohibited and image capture with the image capture region 18A or with another of the electronic cassettes 10 is prompted.

In a case in which irradiation of a specific radiation amount is performed initially to the electronic cassette 10 each day of image capture as calibration to correct the device state, the sensitivity of the scintillator layer 28A may be detected when performing the calibration on each day. Then, during each image capture day, the cumulative irradiation amount that has been irradiated may be derived, and the sensitivity of the scintillator layer 28A may be estimated based on an assumption that the sensitivity of the 28A detected during calibration will fall according to the increase in cumulative irradiation amount as shown in FIG. 28. Alternatively, the sensitivity of the scintillator layer 28A may be estimated based on the irradiation duration and the cumulative irradiation amount during irradiation of radiation for image capture, and the duration maintained in a state of no radiation irradiation.

Further, in the electronic cassette 10, when the sensitivity of the scintillator layer 28A has become less than the tolerable sensitivity, the reduced sensitivity of the scintillator layer 28A may be rapidly recovered by, for example, causing the control unit 14 to generate heat during the night, thereby warming the image capture unit 12 with the heat from the control unit 14, and maintaining a high temperature of the scintillator layer 28A. However, if the electronic cassette 10 is housed in a housing device such as a cradle, the housing device may warm the electronic cassette 10 during the night and maintains a high temperature for the scintillator layer 28A.

In each of the exemplary embodiments, explanation is of cases in which the image capture section 21 is configured with an intermediate conversion type radiation detector 20, such that radiation is first converted into light in the scintillator layer 28, the converted light further converted into charge in the photoconductive layers 30 and then accumulated. However, embodiments are not limited thereto. For example, one side of the image capture section 21 may be configured with a direct conversion type radiation detector, for example employing amorphous selenium or the like in the sensor portions, to directly convert radiation into charge and accumulate the charge.

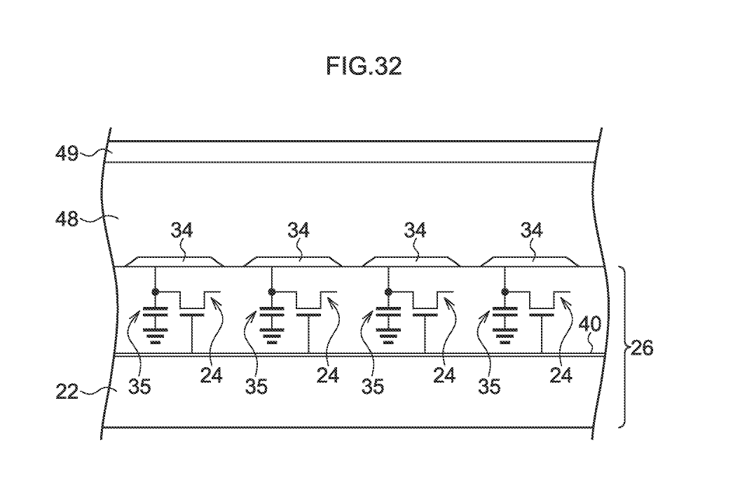

In a direct conversion type radiation detector, as shown in FIG. 32, a photoconductive layer 48 for converting incident radiation into charge is formed on a TFT substrate 26, as an example of a radiation conversion layer.

One or more of the following chemical compounds may be employed as a principal component for the photoconductive layer 48: amorphous Se, Bi₁₂MO₂₀ (M:Ti, Si, Ge), Bi₄M₃O₁₂ (M:Ti, Si, Ge), Bi₂O₃, BiMO₄ (M: Nb, Ta, V), Bi₂WO₆, Bi₂₄B₂O₃₉, ZnO, ZnS, ZnSc, ZnTe, MNbO₃ (M: Li, Na, K), PbO, HgI₂, PbI₂, CdS, CdSe, CdTe, BiI₃, GaAs, and the like. Among these, a non-crystalline (amorphous) material is preferable which has high dark-resistance, shows good photoconductivity to X-ray radiation, and is capable of forming a film of large surface area at a low temperature using a vacuum deposition method.

A bias electrode 49 is formed on the photoconductive layer 48 on the surface on the front face side of the photoconductive layer 48, in order to apply a bias voltage to the photoconductive layer 48.

In a direct conversion type radiation detection device, similarly to an indirect conversion type radiation detection device, charge collecting electrodes 34 are formed on the TFT substrate 26 to collect the charge that has been generated in the photoconductive layer 48.

In the TFT substrate 26 of the direct conversion type radiation detection device, charge storage capacitors 35 are provided for accumulating charge that has been collected by each of the charge collecting electrodes 34. The charge accumulated by each of the charge storage capacitors 35 may be read by switch elements 24.

In each of the exemplary embodiments, the electronic cassette 10 may detect initiation of radiation irradiation by any one of the image capture systems in the image capture section 21. For example, the cassette controller 58 may repeatedly read out image information (data) from one of the radiation detector 20A or 20B during capture of a radiographic image by controlling the gate line driver 52A or 52B such that an ON signal is repeatedly output to the gate line 40 of the one of the radiation detector 20A or 20B in sequence one line at a time, and may detect initiation of radiation irradiation based on variations in pixel values in the read image data.

In the radiation detector 20, charges may be accumulated in the sensor portions 36 even while no radiation is irradiated due to charge generation by dark current or the like. Therefore, the cassette controller 58 may perform a reset operation for discharging charges that have been accumulated due to dark current or the like in each of the sensor portions 36 by outputting an ON signal to each of the gate lines 40 of the radiation detectors 20A and 20B at timings when initiation of radiation irradiation is detected, stand by for a predetermined radiation irradiation period thereafter, and perform reading out of image information (data) from the radiation detectors 20A and 20B after completion of the irradiation of radiation X. This configuration allows reduction of noise due to dark current to a low level in a radiographic image obtained by the image reading-out.

Alternatively, the detection of initiation of radiation irradiation may be performed at another device other than the radiation detectors 20A and 20B.

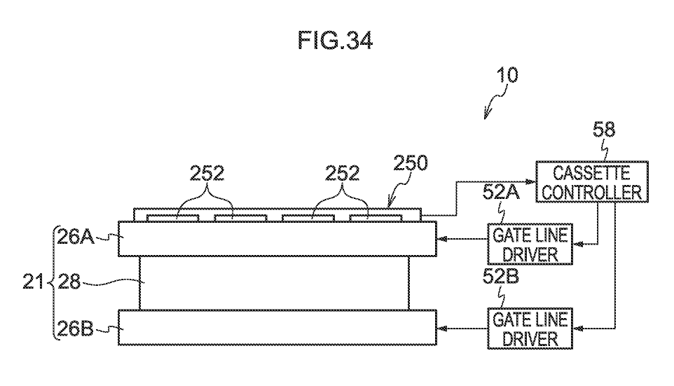

For example, FIG. 34 shows a configuration in which a detection panel 250 provided with plural sensors 252 that can detect radiation is disposed at one side of the image capture section 21 shown in FIG. 25.

In this case, the cassette controller 58 may detect initiation of radiation irradiation based on signals provided from each of the sensors 252 of the detection panel 250, and perform the reset operation by controlling the gate line drivers 52A and 52B at timings when the initiation of radiation irradiation has been detected.

Configurations of the electronic cassette 10 and the radiation detector 20 explained in the above exemplary embodiments are merely examples thereof, and obviously appropriate changes are possible within a scope not departing from the spirit of the present invention.

What is claimed is:

1. A radiographic image capturing device comprising:
two radiation detectors, each radiation detector comprising a light generation layer that generates light due to irradiation of radiation, and a substrate that accumulates charge by receiving light generated at the light generation layer and includes switch elements for reading the charge, and the two radiation detectors being superimposed on each other; and
a light blocking layer disposed between the two radiation detectors, the light blocking layer blocking light generated by each of the light generation layers of the two radiation detectors from the other light generation layer.

2. The radiographic image capturing device of claim 1, wherein the two radiation detectors are disposed such that the light generation layers are disposed such that the light blocking layer is sandwiched between the radiation detectors.

3. The radiographic image capturing device of claim 1, wherein the light blocking layer comprises a rigid light blocking substrate.

4. The radiographic image capturing device of claim 1, wherein the light generation layers of the two radiation detectors have different light generation characteristics from each other in response to radiation.

5. The radiographic image capturing device of claim 4, wherein the light generation layers of the two radiation detectors differ from each other in at least one of: thickness of each of the light generation layers; diameter of particles filled in each of the light generation layers and generating light by irradiation with radiation; multi-layer structure of the particles; fill rate of the particles; doping amount of an additive; material of each of the light generation layers; layer structure of each of the light generation layers; or whether a reflection layer reflecting the generated light is formed at a side of each of the light generation layers which is not facing the substrate.

6. The radiographic image capturing device of claim 4, wherein one of the light generation layers of the two radiation detectors has light generation characteristics that are image sharpness focused, and the other of the light generation layers has light generation characteristics that are sensitivity focused.

7. The radiographic image capturing device of claim 1, wherein the radiation is irradiated from one side of the radiographic image capturing device, and
the two radiation detectors are stacked such that the respective substrates and light generation layers are disposed in this order from the radiation irradiated side.

8. The radiographic image capturing device of claim 7, wherein the light generation layer of at least one of the two radiation detectors that is disposed at the radiation irradiated side comprises an organic material.

9. The radiographic image capturing device of claim 1, wherein at least one of the light generation layers of the two radiation detectors comprises columnar crystals of a fluorescent material that generates light due to irradiating of radiation.

10. The radiographic image capturing device of claim 1, wherein the substrates of the two radiation detectors have different reading characteristics of electrical signals corresponding to read accumulated charge.

11. The radiographic image capturing device of claim 1, wherein the light blocking layer shields radiation.

12. The radiographic image capturing device of claim 1 further comprising:
a generation section capable of separately reading charge accumulated in the two radiation detectors, the generation section reading the charge accumulated as electrical signals and generating image data expressing a radiographic image based on the electrical signals read;
a reception section that receives processing conditions for the two radiation detectors; and
a management section capable of selectively performing processing for the two radiation detectors and managing processing for the two radiation detectors according to the processing conditions.

13. The radiographic image capturing device of claim 12, wherein the processing includes at least one of: charge reading from the two radiation detectors by the generation section, image processing on image data generated by the generation section, transmission of the image data generated by the generation section, transmission of the image processed image data, saving the image data generated by the generation section or saving the image processed image data.

14. The radiographic image capturing device of claim 12, further comprising:
an image capture unit formed in a flat plate shape, that comprises the two radiation detectors and the light blocking layer, and that is capable of capturing a radiographic image of radiation irradiated from either of two sides of the flat plate;
a control unit that comprises the reception section and the management section; and
a connection member connecting the image capture unit and the control unit so as to be opened in an open state in which the image capture unit and the control unit are disposed side-by-side, and to be closed in a folded state in which the image capture unit and the control unit are folded over and superimposed on each other.

15. The radiographic image capturing device of claim 12, further comprising:
an image capture unit formed in a flat plate shape, that comprises the two radiation detectors and the light blocking layer, and that is capable of capturing a radiographic image of radiation irradiated from either of two sides of the flat plate;
a control unit that comprises the reception section and the management section; and
a connection member connecting the image capture unit and the control unit such that the image capture unit is reversible from one face to the other face with respect to the control unit.

16. A radiographic image capturing device comprising:
an image capture section comprising at least two image capture systems that capture radiographic images expressing irradiated radiation, the image capture section being capable of separately reading image data expressing radiographic images captured by each of the image capture systems;
a reception section that receives processing conditions for each of the image capture systems of the image capture section; and
a management section capable of performing selective processing for each of the image capture systems and managing processing for each of the image capture systems according to the processing conditions.

17. The radiographic image capturing device of claim 16, wherein the image capture section comprises two of the light generation layers and a light blocking layer that blocks light, the light generation layers and the substrates being respectively stacked on two sides of the light blocking layer.

18. The radiographic image capturing device of claim 17, wherein the two light generation layers have different light generation characteristics from each other in response to radiation.

19. The radiographic image capturing device of claim 18, wherein the two light generation layers differ from each other in at least one of: thickness of each of the light generation layers; diameter of particles filled in each of the light generation layers and generating light due to irradiation of radiation; multi-layer structure of the particles; fill rate of the particles; doping amount of an additive; material of each of the light generation layers; layer structure of each of the light generation layers; or whether a reflection layer that reflects the generated light is formed at a side of each of the light generation layers which is not facing the substrate.

20. The radiographic image capturing device of claim 17, wherein one of the two light generation layers has light generation characteristics that are image quality focused, and the other of the light generation layers has light generation characteristics that are sensitivity focused.

21. The radiographic image capturing device of claim 17, wherein at least one of the two light generation layers comprises columnar crystals of a fluorescent material that generates light due to irradiating of radiation.

22. The radiographic image capturing device of claim 17, wherein the two substrates have different reading characteristics of electrical signals corresponding to read accumulated charge.

23. The radiographic image capturing device of claim 16, further comprising:
an image capture unit formed in a flat plate shape, that comprises the image capture section, and that is capable of capturing a radiographic image of radiation irradiated from either of two sides of the flat plate;
a control unit that comprises the reception section and the management section; and
a connection member connecting the image capture unit and the control unit so as to be opened in an open state in which the image capture unit and the control unit are disposed side-by-side, and to be closed in a folded state in which the image capture unit and the control unit are folded over and superimposed on each other.

24. The radiographic image capturing device of claim 16, further comprising:
an image capture unit formed in a flat plate shape, that comprises the image capture section, and that is capable of capturing a radiographic image of radiation irradiated from either of two sides of the flat plate;
a control unit that comprises the reception section and the management section; and
a connection member connecting the image capture unit and the control unit such that the image capture unit is reversible from one face to the other face with respect to the control unit.
